(19) United States
(12) Patent Application Publication
(10) Pub. No.: US 2026/0212046 A1
(43) Pub. Date: Jul. 23, 2026

(54) SYSTEMS AND METHODS FOR PROVIDING MEDIA CONTENT

(71) Applicant: Adfixus Pte Ltd, SBF Center (SG)

(72) Inventors: Marko Markovic, Wollstonecraft, New South Wales (AU); Wayne Schwebel, Lindfield, New South Wales (AU)

(21) Appl. No.: 19/141,202

(22) PCT Filed: Dec. 20, 2023
(86) PCT No.: PCT/AU2023/051338

§ 371 Date: Jun. 19, 2025

Related U.S. Application Data
(63) Continuation of application No. 18/069,286, filed on Dec. 21, 2022, now Pat. No. 11,960,628.

(30) Foreign Application Priority Data
Dec. 23, 2022 (AU) 2022291633
Jun. 20, 2023 (AU) 2023203866

(51) Int. Cl. G06F 21/62; H04L 67/02; H04L 67/146; H04L 67/50

(52) U.S. Cl. CPC G06F 21/6263; H04L 67/02; H04L 67/146; H04L 67/535

(57) ABSTRACT

A propagation server for facilitating propagation of recorded information between first-party data structures associated with different domains, the propagation server associated with a propagation domain, the propagation server configured to: receive a first request from a first web browser of a first client device identifying a first domain being a web domain different to the propagation domain; determine whether a propagation data structure, being a first party data structure associated with the propagation domain, is present on the first web browser; when present: determine an identifier from the propagation data structure; generate first propagation information in dependence on the identifier enabling determination of the identifier by the propagation server in a subsequent data communication instance between the first web browser and the propagation server, said subsequent data communication instance is identified as being associated with the first domain; and communicate the first propagation information to the first web browser.

### RELATED APPLICATIONS

The present application claims convention priority from U.S. patent application Ser. No. 18/069286 (filing date 21 Dec. 2022), Australia patent application no. 2022291633 (filing date 23 Dec. 2022), and Australia patent application no. 2023203866 (filing date 20 Jun. 2023). The entire content of each of which is incorporated herein by reference.

### FIELD

Aspects of the disclosure may generally relate to methods for utilising first-party cookies in place of third-party cookies and/or generally relates to a method, system, device, and/or application for enabling a native application to implement a responsive display of received media, such as video or rich media.

### BACKGROUND

Web browsing has developed from simple hyper-text linking between static web pages to a dynamic interconnection of many static and dynamically generated websites providing extensive content.

As browsing developed, a need to be able to record information associated with websites was addressed by enabling websites to set “cookies”—small pieces of data stored on a computer running a web browser in response to an instruction made by a website being accessed by the web browser.

A cookie can be a “first-party cookie” or a “third-party cookie”. The former are set by the particular domain being accessed by the web browser. For example, a user may direct the web browser to www.example.com, and the web content accessed at this domain by the web browser may instruct recording of a cookie containing data and associated with the same domain (hence the term “first-party”). The latter are set by a different domain to that being accessed by the web browser. For example, the web page being accessed at www.example.com may itself utilise resources of another domain, for example, www.addomain.com. This resource may itself set a cookie—however, as it is associated with a different domain, the cookie is associated with the second domain. Hence, the cookie is a third-party cookie; it is associated with a different party to that of the domain being accessed by the web browser.

There has been a trend of preferring to not allow setting of third-party cookies—for example, as a user is not necessarily aware of the second domain, setting of a third-party cookie may be considered undesirable. However, third-party cookies play an important role in modern online activities, providing means to track activity among different websites (for example, for providing targeted advertising) and to allow for more efficient user identification. For example, a common owner of several websites (each associated with a different domain) may have legitimate interests in identifying a user when that user visits its unique websites; the removal of third-party cookies, although for the positive reason of improving user privacy and security, is likely to have negative consequences in these circumstances.

As an example, when user (via a web browser) accesses a known domain, such as www.example.com, it may generate at least some of the content for the user by utilising resources from a third-party domain, for example www.addomain.com. In the past, www.addomain.com may set a third-party cookie (for example, with name=AdDomainId and value=12345). In terms of a browser functionality, this cookie is related to www.addomain.com rather than www.example.com. When a user further navigates to www.example1.com, a domain totally unrelated to www.example.com and owned by another company, that which also utilises resources of www.addomain.com, in the past the browser would automatically send the cookie for www.addomain.com to www.addomain.com. This means that a cookie that was previously set on www.example.com (name=AdDomainId with value=12345) is automatically sent from www.example1.com.

Therefore, recently, several major web browser developers have announced plans to disable third-party cookies by default. Such an action is predicted to have an adverse consequence on legitimate online activity.

The modern web browsing experience also includes visiting website in which third-party content is presented at the same time as that of the website publisher (first-party content). Often this third-party content comprises adverts, public service announcements, political information, and more. The third-party content is often provided by a separate webserver (for example, an ad server) to that of the first-party content.

A web user uses a client device (for example, a web user may utilise a mobile phone—typically those referred to as “smartphones”, a tablet, a personal computer) to access the website via a web browser. A web browser is an application running on the client device configured to access web resources, process the web resources, and present resulting web content via a user interface of the client device. From the perspective of the user, the web content is equivalent to the website, however, in practice the web content varies on subsequent visits to the website (often, in fact, the web content varies during the same visit, for example, on dynamic websites such as those provided by social media).

Modern web browsers are sophisticated programs capable of interpreting several different programming languages and determining a suitable means for presenting the web content. Often, the web resources define different presentations of the web content which at least are dependent on the features of the particular client device; for example, in terms of a two-dimensional electronic display, the physical size and/or resolution of the display available to the web browser (noting that this may be a smaller size and/or resolution than the entire electronic display, such as when the web browser is limited to a sub-region of the display size).

Often third-party content is identified on an as-needed basis. For example, the web resources may define one or more third-party content regions within a web page (such as one or more advert regions). A request is then made to a third-party content server identified by the web resources for suitable third-party content. The particular third-party content returned can be highly variable. For example, where the third-party content represents adverts, the third-party content server can undertake a procedure for deciding which advert(s) to return. This often includes an automated bidding procedure effectively allowing advert owners to make commercial payments to improve the chances of their adverts being selected. Advert selection can also be based on known information related to the web user themselves (or, at least, their client device accessing the web page), thus enable a tailored selection of adverts to be presented to the user.

### SUMMARY

Certain embodiments described herein may be understood generally as being directed towards providing mechanisms for enabling functionality provided by third-party cookies without requiring the setting of third-party cookies. For example, certain described embodiments may be suitable for providing functionality to enable tracking of particular users amongst several different websites associated with different domains, which may advantageously enable identification of a user by said different websites in a manner invisible to said user. Advantageously, identification of a user may allow the different websites to offer suitably tailored content based on the user identification, thereby providing an improved user experience across the various websites and domains. These and other advantages are generally achieved without setting third-party cookies, which previously have been utilised to provide such function. In order to strike a balance between legitimate tracking activities and the desire for user privacy and security, certain described embodiments provide for additional limitations on the extent to which user identifying information is made available.

The present disclosure includes a propagation server for facilitating propagation of recorded information between first-party data structures associated with different domains, the propagation server arranged for data communication via a network with web browsers of client devices, wherein the propagation server is associated with a propagation domain being a web domain, wherein the propagation server is configured to: receive a first request from a first web browser, said first web browser associated with a first client device, wherein the first request identifies a first domain being a web domain different to the propagation domain; determine, via data communication with the first web browser, whether a propagation data structure, being a first party data structure associated with the propagation domain, is present on the first web browser; in a case where the propagation data structure is present: determine an identifier from information stored with the propagation data structure; generate first propagation information in dependence on the identifier, said first propagation information enabling determination of the identifier by the propagation server in a subsequent data communication instance between the first web browser and the propagation server, wherein said subsequent data communication instance is identified as being associated with the first domain; and communicate the first propagation information to the first web browser.

Optionally, the propagation server is configured to: in a case where the propagation data structure is not present: generate an identifier; generate the first propagation information in dependence on the generated identifier, said first propagation information enabling determination of the generated identifier by the propagation server in a subsequent data communication instance between the first web browser and the propagation server, wherein said subsequent data communication instance is identified as being associated with the first domain; and communicate the first propagation information to the first web browser. The propagation server may be configured to: in response to determining that a propagation data structure is not present, cause a presentation of a user control interface on the first web browser enabling a user of the first web browser to define one or more propagation rules for storing in a propagation rules data structure on the first web browser, wherein the one or more propagation rules are not accessible to data communications from domains different to the propagation domain, and wherein the propagation information is generated in dependence on the defined one or more propagation rules.

Optionally, the propagation server is configured to: receive a propagation rules edit request from the first web browser; in response, cause a presentation of a configuration interface on the first web browser enabling a user of the first web browser to define and/or modify one or more propagation rules for storing in a propagation rules data structure on the first web browser, wherein the one or more propagation rules are not accessible to data communications from domains different to the propagation domain, and wherein the propagation information is generated in dependence on the defined one or more propagation rules.

Optionally, the propagation information is also generated in dependence on one or more propagation rules associated with the propagation data structure. The one or more propagation rules may define at least two groups of one or more domains. In this case, each group may comprise different domains to the other groups, such that the propagation information generated in dependence on a particular identifier is the same for domains of a group and different for domains of different groups. The propagation server may be interfaced with a match module arranged for data communication via the network, the match module configured to: receive a first request associated with a first group of the at least two groups, wherein the request identifies one or more first identifiers and specifies at least one second group of the at least two groups, the at least one second group being different to the first group; obtain second propagation information associated with one or more web browsers from the second group, and convert the second propagation information into one or more second identifiers, each associated with one of the one or more web browsers; identify, for each of the one or more first identifiers, a match state indicative of the presence or non-presence of an identical second identifier; and communicating a response to the first group indicating the match state for each of the one or more first identifiers. The match module may be implemented by the propagation server. The first request may provide first propagation information associated with one or more web browsers and the match module may convert said first propagation information into the one or more first identifiers, thereby identifying the one or more first identifiers. The match module may maintain a record of match rules for a plurality of identifiers, and the identified match state for at least one first identifier may be dependent on an allowability rule defined the match rule for that at least one identifier.

Optionally, the propagation server encrypts the identifier to thereby generate an encrypted identifier for storing with the propagation data structure, and decrypts the encrypted identifier when determining the identifier.

Optionally, the propagation server maintains a database of propagation keys, each propagation key associated with one or more domains, and generation of the propagation information comprises encrypting the identifier utilising a first propagation key being associated with the first domain.

The present disclosure also includes a network system is provided comprising the propagation server. The described network system further comprises one or more domain servers, each arranged for data communication via a network with the web browsers of the client devices and each associated with a unique domain, wherein the propagation domain is different to the domains of the domain servers, and wherein each domain server is configured to: receive a communication from a web browser; determine whether a first domain data structure is associated the communication, the first domain data structure associated with the domain of the domain server; in response to determining that there is not a first data structure present, obtain from the web browser propagation information, the propagation information having been obtained by the web browser due to the first request communicated to the propagation server; generate first domain data structure information based on the received propagation information instruct the web browser to record in a new first domain data structure the first domain data structure information.

Optionally, the first domain data structure information by encrypting the propagation information utilising a first domain key known to the domain server, the first domain key not utilised in generating the propagation information from the identifier. The propagation server may encrypt the identifier to thereby generate an encrypted identifier for storing with the propagation data structure. The propagation server may decrypt the encrypted identifier when determining the identifier. Each domain server may be configured to generated associated domain data structure information by encrypting received propagation information utilising a domain key known to the particular domain server. Each domain server may be configured to: receive the propagation information from the web browser after the web browser is instructed to communicate with the propagation server, said propagation information provided to the web browser due to its communication with the propagation server.

The present disclosure also includes a propagation server for facilitating propagation of recorded information between first-party data structures associated with different domains, the propagation server arranged for data communication via a network with web browsers of client devices, wherein the propagation server is associated with a propagation domain being a web domain, wherein the propagation server is configured to: receive a first request from a first web browser, said first web browser associated with a first client device, wherein the first request identifies a first domain being a web domain different to the propagation domain; determine, via data communication with the first web browser, whether a propagation data structure, being a first party data structure associated with the propagation domain, is present on the first web browser; in a case where the propagation data structure is not present: generate an identifier; generate the first propagation information in dependence on the generated identifier, said first propagation information enabling determination of the generated identifier by the propagation server in a subsequent data communication instance between the first web browser and the propagation server, wherein said subsequent data communication instance is identified as being associated with the first domain; and communicate the first propagation information to the first web browser.

Optionally, the propagation data structure comprises a propagation cookie in which at least the information for determining the identifier is stored.

The present disclosure also includes a method for facilitating propagation of recorded information between first-party data structures associated with different domains, the method comprising: at a propagation server arranged for data communication via a network with web browsers of client devices, wherein the propagation server is associated with a propagation domain being a web domain: receiving a first request from a first web browser, said first web browser associated with a first client device, wherein the first request identifies a first domain being a web domain different to the propagation domain; determining, via data communication with the first web browser, that a propagation data structure is present, being a first party data structure associated with the propagation domain, is present on the first web browser; in response, determining an identifier from information stored with the propagation data structure; generating first propagation information in dependence on the identifier, said first propagation information enabling determination of the identifier by the propagation server in a subsequent data communication instance between the first web browser and the propagation server, wherein said subsequent data communication instance is identified as being associated with the first domain; and communicating the first propagation information to the first web browser.

The present disclosure also includes a method for facilitating propagation of recorded information between first-party data structures associated with different domains, the system comprising: at a propagation server arranged for data communication via a network with web browsers of client devices, wherein the propagation server is associated with a propagation domain being a web domain: receiving a first request from a first web browser, said first web browser associated with a first client device, wherein the first request identifies a first domain being a web domain different to the propagation domain; determining, via data communication with the first web browser, that a propagation data structure, being a first party data structure associated with the propagation domain, is present on the first web browser, is not present; in response, generating an identifier; generating the first propagation information in dependence on the generated identifier, said first propagation information enabling determination of the generated identifier by the propagation server in a subsequent data communication instance between the first web browser and the propagation server, wherein said subsequent data communication instance is identified as being associated with the first domain; and communicating the first propagation information to the first web browser.

The present disclosure also includes a method for providing a responsive display of content rendered in an embedded browser on a client device having a display and a user interface for receiving instructions from a user of the client device and being configured for data communication with a network, comprising: running a native application on the client device, wherein the native application is configured for presenting on the display of the client device a visual representation of both of received primary content data and received secondary content data, wherein the native application is configured for generating a presentation of the received primary content data, wherein the secondary content data is associated with received metadata readable to the native application and comprises a payload defining presentable media content, wherein the payload is not readable by the native application, and wherein the native application utilises the embedded browser for generating and displaying a presentation of the payload; receiving, by the native application via the network, secondary content data from a secondary content server in response to a request for primary content data being communicated to the primary content server; determining, by the native application, whether the metadata indicates that the payload defines a variable media format indicative that the received media content is suitable for presentation at a native application determined display size; and in response to determining that the payload defines a variable media format: determining, by the native application, a system specific display resolution for presenting the media content defined by the payload, wherein the system specific display resolution is determined independently of a secondary content display resolution defined by the metadata, and instructing, by the native application, the embedded browser to generate and display a presentation of the payload on the display of the client device at a display size equal to the determined system specific display resolution.

Optionally, the payload defines a first presentation of media content utilised at a first display size of the embedded browser and a second presentation of media content utilised at a second display size of the embedded browser different to the first display size. The second presentation may be required to be different to a scaling of the first presentation.

Optionally, the method further comprises: in response to determining that the payload does not define a variable media format: identifying, by the native application, the secondary content display resolution defined by the metadata for presenting the media content defined by the payload, and instructing, by the native application, the embedded browser to generate and display a presentation of the payload on the display of the client device at a display size equal to the secondary content display resolution.

Optionally, the metadata comprises a display resolution value, and the payload may be determined to define a variable media format in a case wherein the display resolution value is equal to a predefined value. The secondary content display resolution may be determined to be equal to the display resolution parameter.

Optionally, the method further comprises communicating, by the native application, the request for primary content data to the primary content server before receiving the secondary content data.

Optionally, the method further comprises: receiving, by the native application via the network, primary content data from the primary content server in response to the request for primary content data being communicated to the primary content server; generating, by the native application, a presentation of the primary content data; and displaying, by the native application, the presentation of the primary content data on the display of the client device, wherein the presentation of the primary content data by the native application and the presentation of the payload by the embedded browser are elements of a combined presentation, wherein the displaying of the presentation of the primary content data and the presentation of the payload correspond to the client device presenting on its display the combined presentation. The combined presentation may have a display size larger than a content display area corresponding to a portion or all of a physical display size of the display, and the user may be enabled to control the client device via the user interface to display different portions of the combined presentation.

Optionally, the request for primary content data comprises a search request and the primary content data comprises search results generated in dependence on the search request.

Optionally, the secondary content server selects the secondary content data for sending to the client device according to a request for secondary content data communicated to the secondary content server specifying a plurality of allowable secondary media display sizes, such that the secondary content data is associated with a one of the allowable secondary media display sizes. The method may further comprise communicating, by the native application, the request for secondary content data to the secondary content server before receiving the secondary content data. The allowable secondary media display sizes may each have at least one display parameter value equal to or smaller than a corresponding physical display resolution of the display of the client device.

Optionally, the payload comprises web browser executable code and the embedded browser may be configured to generate the presentation of the payload by reading the web browser executable code in accordance with the determined embedded browser display size.

The present disclosure also includes a client device comprising a processor operably interfaced with a memory, a display, a user interface for receiving instructions from a user of the client device, and a network interface for enabling data communication between the client device and a network, wherein the display has a physical display size, wherein the memory comprises code defining operation of a native application, wherein the native application is configured to cause, when executed by the processor, the client device to provide a responsive display of content rendered in an embedded browser, and wherein the native application is configured to cause the client device to: receive via the network secondary content data from a secondary content server in response to a request for primary content data being communicated to the primary content server, wherein the secondary content data is associated with received metadata readable by the native application and comprising a payload defining presentable media content, wherein the payload is not readable by the native application; determine whether the metadata indicates that the payload defines a variable media format indicative that the received media content is suitable for presentation at a native application determined display size; and in response to determining that the payload defines a variable media format: determine a system specific display resolution for presenting the media content defined by the payload, wherein the system specific display resolution is determined independently of a secondary content display resolution defined by the metadata, and instruct an embedded browser of the client device to generate and display a presentation of the media content of the payload on the display at a display size equal to the determined system specific display resolution.

Optionally, the payload defines a first presentation of media content utilised at a first display size of the embedded browser and a second presentation of media content utilised at a second display size of the embedded browser different to the first display size. The second presentation may be required to be different to a scaling of the first presentation.

Optionally, the native application is configured to cause the client device to: in response to determining that the payload does not define a variable media format: identify the secondary content display resolution defined by the metadata for presenting the media content defined by the payload, and instruct the embedded browser to generate and display a presentation of the payload on the display at a display size equal to the secondary content display resolution.

Optionally, the metadata comprises a display resolution value, and the payload may be determined to define a variable media format in a case wherein the display resolution value is equal to a predefined value. The secondary content display resolution may be determined to be equal to the display resolution parameter.

Optionally, the native application is configured to cause the client device to communicate the request for primary content data to the primary content server before receiving the secondary content data.

Optionally, the native application is configured to cause the client device to: receive via the network the primary content data from the primary content server in response to the request for primary content data being communicated to the primary content server; generate a presentation of the primary content data; and display the presentation of the primary content data on the display of the client device, wherein the presentation of the primary content data by the native application and the presentation of the payload by the embedded browser are elements of a combined presentation, wherein the displaying of the presentation of the primary content data and the presentation of the payload correspond to the client device presenting on its display the combined presentation. The combined presentation may have a display size larger than a content display area corresponding to a portion or all of a physical display size of the display, and the user may be enabled to control the client device via the user interface to display different portions of the combined presentation.

Optionally, the request for primary content data comprises a search request and the primary content data comprises search results generated in dependence on the search request.

Optionally, the secondary content server selects the secondary content data for sending to the client device according to a request for secondary content data communicated to the secondary content server specifying a plurality of allowable secondary media display sizes, such that the secondary content data is associated with a one of the allowable secondary media display sizes. The native application may be configured to cause the client device to communicate the request for secondary content data to the secondary content server before receiving the secondary content data. The allowable secondary media display sizes may each have at least one display parameter value equal to or smaller than a corresponding physical display resolution of the display of the client device.

Optionally, the payload comprises web browser executable code and wherein the embedded browser is configured to generate the presentation of the payload by reading the web browser executable code in accordance with the determined embedded browser display size.

The present disclosure also includes a media content delivery system comprising: one or more client devices, each according to the previously described embodiment; a primary content server configured to receive primary content requests from the one or more client devices via a network and to communicate primary content responses to requesting client devices; and a secondary content server configured to communicate secondary content responses to client devices, wherein a particular secondary content response is generated in response to the secondary content server receiving a particular secondary content request and is communicated to a particular client device identified by the secondary content request.

Optionally, the secondary content server stores a plurality of instances of secondary content, in which each instance of secondary content is associated with a particular secondary media display size, the secondary content request defines a plurality of allowable secondary media display sizes, and the secondary content server is configured to select an instance of secondary content for returning as a secondary content response meeting one of the plurality of allowable secondary media display sizes.

Optionally, the one or more client devices are configured to communicate secondary content requests to the secondary content server via the network.

Optionally, the primary content server is configured to communicate secondary content requests to the secondary content server via the network in response to receiving primary content requests from the one or more client devices.

The present disclosure also includes a native application for providing a responsive display of content rendered in an embedded browser on a client device, wherein the client device comprises a processor operably interfaced with a memory, a display, a user interface for receiving instructions from a user of the client device, and a network interface for enabling data communication between the client device and a network, wherein the display has a physical display size, wherein the native application comprises code configured to cause, when said code is executed by said processor, the client device to: receive via the network secondary content data from a secondary content server in response to a request for primary content data being communicated to the primary content server, wherein the secondary content data is associated with received metadata readable by the native application and comprising a payload defining presentable media content, wherein the payload is not readable by the native application; determine whether the metadata indicates that the payload defines a variable media format indicative that the received media content is suitable for presentation at a native application determined display size; and in response to determining that the payload defines a variable media format: determine a system specific display resolution for presenting the media content defined by the payload, wherein the system specific display resolution is at least in part determined according to the physical resolution of the display, and instruct an embedded browser of the client device to generate and display a presentation of the media content of the payload on the display at a display size equal to the determined system specific display resolution.

The native application may be embodiment on a computer readable storage medium.

The present disclosure also includes a method for providing a responsive display of content rendered in an embedded browser on a client device comprising a display and a user interface for receiving instructions from a user of the client device and being configured for data communication with a network, comprising: running a native application on the client device, wherein the native application is configured for presenting to a user of the client device a representation of both of received primary content data and received secondary content data, wherein the native application is configured for generating a presentation of the received primary content data, wherein the secondary content data comprises a payload defining presentable media content, and wherein the native application utilises the embedded browser for generating and presenting a representation of the media content defined by the payload; receiving, by the native application via the network, secondary content data from a secondary content server in response to a request for primary content data being communicated to the primary content server; generating, by the native application, a combined presentation comprising the embedded browser, wherein the combined presentation has a display size larger than a content display area of the display such that a particular portion of the combined presentation is displayable on the display at a time, wherein the user is enabled to provide an input to control the particular portion of the combined presentation being displayed; displaying a first portion of the combined presentation on the display, the first portion comprising the embedded browser, wherein the embedded browser is instructed, by the native application, to present the media content defined by the payload in the first portion according at a first resolution; determining a change such that a second portion of the combined presentation is displayed on the display, the second portion not comprising the embedded browser; and in response, instructing the embedded browser to present the media content defined by the payload at a second resolution, different to the first resolution, wherein the payload is responsive to the change in resolution from the first resolution to the second resolution, such that at least one perceivable element of the presentation of the media content defined by the payload is different at the second resolution when compared to the first resolution.

Optionally, the media content comprises a video perceivable element and an audio perceivable element, and the audio perceivable element may be mute at the second resolution and/or the video perceivable element is paused. The audio perceivable element may be initially mute at the first resolution and is changed to unmute in response to a user input. The payload may be configured to unmute the audio perceivable element when a change from the second resolution to the first resolution occurs on a condition that the audio perceivable element had been set as unmute immediately before the preceding change from first resolution to second resolution.

Optionally, at least one of a value of the first resolution and a value of the second resolution is predefined, such that the payload is configured to identify the first resolution and/or second resolution by identifying the corresponding predefined value. The payload may be configured to identify the first resolution as corresponding to a resolution of the embedded browser at the time at which the payload is initially executed. At the time of generating the combined presentation, in the case that embedded browser is initially not displayed, the embedded browser may be set at the first resolution and changed subsequently to the second resolution, such that the payload is enabled to determine the value of the first resolution. The second resolution may be determined as a relative change to the first resolution. The second resolution may be different to the first resolution by a predefined amount. The predefined amount may be a reduction by one pixel. The first resolution and second resolution may correspond to either or both of: a height number of pixels; and a width number of pixels.

The present disclosure also includes a client device comprising a processor operably interfaced with a memory, a display, a user interface for receiving instructions from a user of the client device, and a network interface for enabling data communication between the client device and a network, wherein the memory comprises code defining operation of a native application, wherein the native application is configured to cause, when executed by the processor, the client device to provide a responsive display of content rendered in an embedded browser, and wherein the native application is configured to cause the client device to: receive, by the native application via the network, secondary content data from a secondary content server in response to a request for primary content data being communicated to the primary content server, wherein the secondary content data comprises a payload defining presentable media content, and wherein the native application utilises the embedded browser for generating and presenting a representation of the media content defined by the payload; generate, by the native application, a combined presentation comprising the embedded browser, wherein the combined presentation has a display size larger than a content display area of the display such that a particular portion of the combined presentation is displayable on the display at a time, wherein the user is enabled to provide an input to control the particular portion of the combined presentation being displayed; display a first portion of the combined presentation on the display, the first portion comprising the embedded browser, wherein the embedded browser is instructed, by the native application, to present the media content defined by the payload in the first portion according at a first resolution; determine a change such that a second portion of the combined presentation is displayed on the display, the second portion not comprising the embedded browser; and in response, instruct the embedded browser to present the media content defined by the payload at a second resolution, different to the first resolution, wherein the payload is responsive to the change in resolution from the first resolution to the second resolution, such that at least one perceivable element of the presentation of the media content defined by the payload is different at the second resolution when compared to the first resolution.

Optionally, the media content comprises a video perceivable element and an audio perceivable element, and the audio perceivable element may be mute at the second resolution. The audio perceivable element may be initially mute at the first resolution and may be changed to unmute in response to a user input. The payload may be configured to unmute the audio perceivable element when a change from the second resolution to the first resolution occurs on a condition that the audio perceivable element had been set as unmute immediately before the preceding change from first resolution to second resolution.

At least one of a value of the first resolution and a value of the second resolution may be predefined, such that the payload is configured to identify the first resolution and/or second resolution by identifying the corresponding predefined value. The payload may be configured to identify the first resolution as corresponding to a resolution of the embedded browser at the time at which the payload is initially executed. At the time of generating the combined presentation, in the case that embedded browser is initially not displayed, the embedded browser may be set at the first resolution and changed subsequently to the second resolution, such that the payload is enabled to determine the value of the first resolution. The second resolution may be determined as a relative change to the first resolution. The second resolution may be different to the first resolution by a predefined amount. The predefined amount may be a reduction by one pixel. The first resolution and second resolution may correspond to either or both of: a height number of pixels; and a width number of pixels.

The present disclosure also includes a native application for providing a responsive display of content rendered in an embedded browser on a client device, wherein the client device comprises a processor operably interfaced with a memory, a display, a user interface for receiving instructions from a user of the client device, and a network interface for enabling data communication between the client device and a network, wherein the memory comprises code defining operation of a native application, wherein the native application is configured to cause, when executed by the processor, the client device to: receive, by the native application via the network, secondary content data from a secondary content server in response to a request for primary content data being communicated to the primary content server, wherein the secondary content data comprises a payload defining presentable media content, and wherein the native application utilises the embedded browser for generating and presenting a representation of the media content defined by the payload; generate, by the native application, a combined presentation comprising the embedded browser, wherein the combined presentation has a display size larger than a content display area of the display such that a particular portion of the combined presentation is displayable on the display at a time, wherein the user is enabled to provide an input to control the particular portion of the combined presentation being displayed; display a first portion of the combined presentation on the display, the first portion comprising the embedded browser, wherein the embedded browser is instructed, by the native application, to present the media content defined by the payload in the first portion according at a first resolution; determine a change such that a second portion of the combined presentation is displayed on the display, the second portion not comprising the embedded browser; and in response, instruct the embedded browser to present the media content defined by the payload at a second resolution, different to the first resolution, wherein the payload is responsive to the change in resolution from the first resolution to the second resolution, such that at least one perceivable element of the presentation of the media content defined by the payload is different at the second resolution when compared to the first resolution.

As used herein, the word “comprise” or variations such as “comprises” or “comprising” is used in an inclusive sense, i.e. to specify the presence of the stated features but not to preclude the presence or addition of further features in various embodiments of the invention.

### BRIEF DESCRIPTION OF THE DRAWINGS

In order that the invention may be more clearly understood, embodiments will now be described, by way of example, with reference to the accompanying drawings, in which:

FIG. 1 shows a communication system according to an embodiment;

FIG. 2 shows an arrangement for cookie propagation for certain embodiments;

FIG. 3 shows a method for propagating cookies, according to an embodiment;

FIGS. 4A and 4B show a particular implementation utilising the method of FIG. 3;

FIGS. 5A and 5B show a method for propagating cookies, according to another embodiment;

FIG. 6 shows a method for generating a domain cookie via a third-party content server;

FIGS. 7A-7C show embodiments for generating a user identifying cookie and propagating the information; and

FIGS. 8A-8E relate to using a proxy server to modify communications to a third-party resource;

FIG. 9 shows an example approach to user control of propagation rules using a webform or popup;

FIG. 10 shows a double encryption approach linking propagation cookies to domain cookies;

FIGS. 11A and 11B show operation of a match module according to embodiments;

FIG. 12 shows a high-level overview of a media content delivery system according to an embodiment;

FIG. 13 shows a situation in which secondary content is intended for display on the client device simultaneously with the primary content;

FIG. 14 shows a method for identifying and presenting received variable media formats, according to an embodiment; and

FIG. 15 shows a method for signalling a status to an embedded media content according to an embodiment.

### DESCRIPTION OF EMBODIMENTS

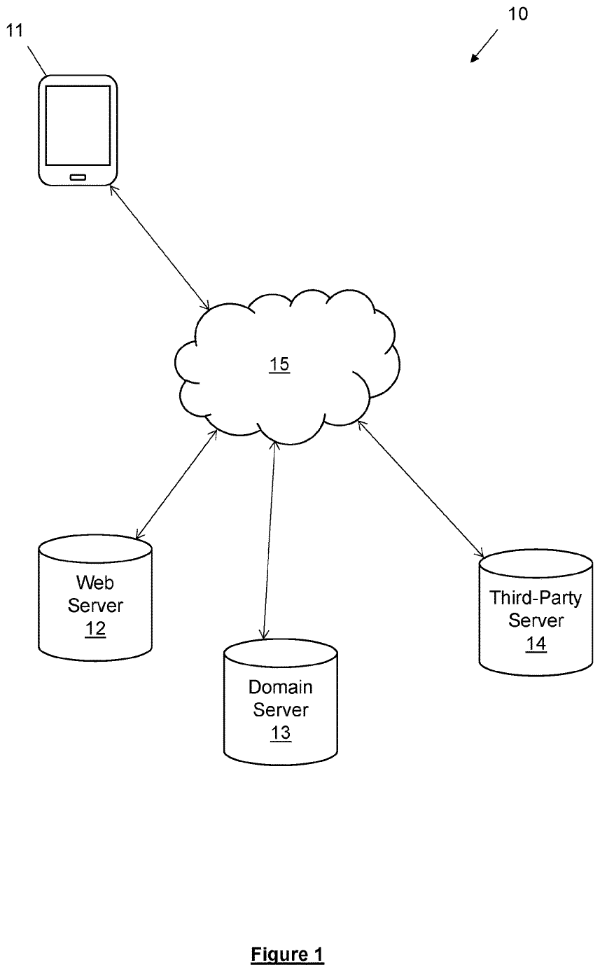

FIG. 1 shows a communication system 10 according to an embodiment. The system 10 comprises a client device 11, a web server 12, a domain server 13, and an optional third-party content server 14. The client device 11 is configured for data communication with the web server 12, domain server 13, and, when applicable, content server 14 via a network 15, typically comprising the Internet. In the embodiment shown, the client device 11 is in data communication with the third-party content server 14 via the domain server 13.

The system 10 of FIG. 1 should be understood as an exemplary representation of data connections between various elements, however, should not be considered limiting; for example, certain embodiments may utilise fewer elements than shown while others may utilise additional elements. Furthermore, the various servers 12-14 should be understood, unless otherwise stated, as representing functional elements—although each server 12-14 may be embodied in separate physical hardware, two or more of said servers 12-14 may be embodied in the same physical hardware, for example as logically distinct elements. Similarly, the client device 11 should be understood, unless otherwise stated, as a functional element allowing a user (or, in fact, users) to interact with the system 11.

The client device 11 is configured to run an application suitable for requesting web content (e.g. via the http protocol), typically a web browser (as assumed herein). The web browser is enabled to communicate with the web server 12 hosting a particular website. For example, the web browser can make such a communication in response to a user input (e.g. by selecting a hyperlink directed towards the website or by entering an URL address of the website) or automatically in response to an instruction made by software executed on the client device 11 (which can be the same web browser).

A client device 11 can be any suitable computing hardware for running the application suitable for requesting web content, such as a personal computer (PC) or smartphone. Other devices are also envisaged, such as smart watches, tablets, and various formfactor of PC including desktop, laptop, and netbook. A common property of said client devices 11 is enablement of network data communication with the network 15, such as wired (e.g. via Ethernet) or wireless (e.g. WiFi—such as one or more of the various IEEE 802.11 standards). For the purposes of the present disclosure, no particular data communication is assumed. The client device 11 can implement any number of operating systems, such as one or more of Microsoft Windows-compatible operating system (OS), Apple OS X, and a Linux distribution. Smartphones are known to implement Android or iOS operating systems, amongst others.

The various servers 12-14 can be implemented in appropriate hardware as desired. For example, each server 12-14 can be implemented in dedicated computing hardware. However, cloud-based implementations are also envisaged, such as provided by Amazon Web Services (AWS), Microsoft Azure, Google Cloud Platform, and Oracle Cloud, in which one or more servers 12-14 are implemented as virtual servers. Generally, each server 12-14 is associated with a processor and memory, wherein the processor executes code to implement the functionality of said server 12-14 and the memory is provided to store said code as well as to provide a working memory space. The memory can comprise both volatile and non-volatile memories. Each server 12-14 is provided with access to said network 15 and/or directly to one or more of the other servers 12-14, depending on the requirements of the particular implementation.

Generally, the network 15 is flexible and may receive data communications via any number of protocols, such as Ethernet, 802.11, worldwide interoperability for microwave access (WiMAX), 3G, 4G, CDMA, digital subscriber line (DSL), etc. Similarly, the networking protocols used on the network 15 can include any number of protocols, such as multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 15 can be represented using technologies and/or formats, for example, one or more of: the hypertext mark-up language (HTML), the extensible mark-up language (XML), and JavaScript Object Notation (JSON). In addition, all or some of communications can be encrypted using conventional encryption technologies such as secure sockets layer (SSL), transport layer security (TLS), and Internet Protocol security (IPsec).

Security is a major consideration in the design of operating systems for smartphones, tablets, smartwatches, and other devices, and often individual native applications are “sandboxed” such that one native application cannot directly interact with another. Sandboxing provides strict control over the resources available to individual applications, in particular, the memory space made available to the application. Operating systems implementing sandboxing can provide controlled mechanisms for data transfer between native applications. Operating systems can also make modules available to native applications to enable implementation of certain functionality without the corresponding code being built into the particular application. For example, a “webview” module is provided on most major computing platforms, including Android and iOS for smartphones and tablets, enabling a native application to “embed” a web browser to display web content. In this way, the web browser functionality is not required to be built into the native application itself.

Reference herein is made to “browser executable code”, with a primary example being JavaScript. JavaScript is a well-known technology of the World Wide Web, itself an application running on the Internet. Although, by some estimates, 97% of websites use JavaScript for client-side web page behaviour (that is, generating web page content and behaviours through execution of JavaScript of the web browser of client devices 11), the particular browser executable code and corresponding programming language should not be considered constraining, unless the context or particular claims dictates otherwise. Relevantly, the browser executable code should be suitable for execution on a web browser of a client device 11 to cause the web browser to undertake communication functions, generate content, or other dynamic behaviours.

Various embodiments are described below for providing functionality without utilising third-party cookies which may be similar in effect (at least, from the perspective of the user of the user device 11) to certain functionality known to be enabled by the setting of third-party cookies. Generally, the scenarios described herein include a web browser accessing an internet resource being a web page (as assumed herein) hosted by the web server 12. The web browser is directed to the address of the web page specified, for example, by its Uniform Resource Locator (URL).

According to embodiments, both the web server 12 and the domain server 13 are configured to receive requests from the client device 11 and to provide a response. For example, a request can be for content and the response can comprise that content. Typically, as assumed herein, the requests are according to the Hypertext Transfer Protocol (HTTP) (or an extension protocol such as Hypertext Transfer Protocol Secure (HTTPS)) “GET” messages and the responses comprise HTTP/HTTPS response messages. Additionally, a response can comprise content including hypertext mark-up language (HTML) code defining an appearance and functionality of the web page. The HTML code define a variety of different pieces of content. The response also comprises HTTP headers.

Generally, when a web browser of user device 11 accesses an internet resource, it can be configured to communicate web page specific data with the request that has previously been stored by the web browser due to a previous access of the internet resource. An example is an ETag (having an ETag value). An ETag is defined as a part of HTTP and is set on the client device 11 by the resource when responding to the request. That is, if the web browser has previously communicated with the resource, it can have stored an ETag value that was set during the previous communication. Generally, the ETag value is specifically associated with the resource, for example, associated with its URL. ETag values can be valid for a time limit or not. In another embodiment, the web page specific data is stored in a local storage accessible to the web browser, for example, via execution of suitable code. For convenience, certain embodiments are described herein which relate to the use of ETags as the web page specific data, although it should be understood this is not intended to be limiting.

The web browser operating on the client device 11 is configured to store data in the form of cookies. The cookies can be of a variety of types known in the art. Relevantly, the web page specific data is not equivalent to a cookie—for example, for the purposes of the present disclosure, the web page specific data is unavailable to executable code.

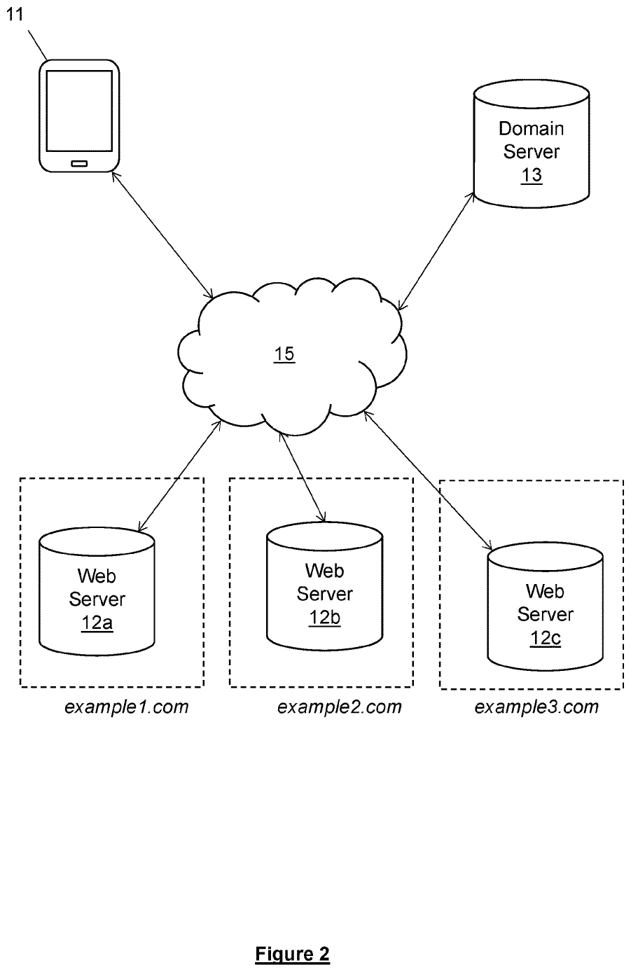

Referring to FIG. 2, a topology is shown relevant for certain embodiments in which a plurality of web servers 12a-12c (generally, any number of web servers 12) are in communication with network 15. Domain server 13 is also shown in communication with the network 15. As with FIG. 1, a representative client device 11 is also shown in communication with the network 15; therefore, client device 11 is enabled to communicate with each web server 12a-12c and the domain server 13 via said network 15.

Relevantly, the web servers 12a-12c are distinguished in that they represent web resources (e.g. web pages) associated with different domains (represented by broken-lined boxes); that is, first web server 12a is associated with a first web page on a first domain (e.g. www.example1.com), second web server 12b is associated with a second web page on a second domain (e.g. www.example2.com), and third web server 12a is associated with a third web page on a third domain (e.g. www.example3.com). Therefore, first-party cookies associated with each web server 12a-12c are not accessible to the other web servers 12a-12c.

One or more embodiments herein described can be utilised to “propagate” cookies between the different domains. Here, “propagate” and “cookie propagation” refer to creating first-party cookies on the client device 11 associated with each domain based on common information. For example, if information is created or determined by a visit by the client device 11 to a web resource of one of the domains (e.g. the first domain) and recorded within a first-party cookie, a subsequent visit to a web resource of another of the domains (e.g. the second domain) results in the recording of the information within a first-party cookie associated with this next visited domain. Therefore, the common information is effectively stored in separate first-party cookies for each web resource of the different domains.

The overall effect is that the common information is “propagated” between cookies for each domain, thereby enabling each web server 12a-12c to generate consistently personalised information by being enabled to identify each visit as being from the same client device 11. In practice, any required information can be propagated. It should also be understood that each domain's cookie can store different actual data (e.g. via domain specific encryption and/or hashing)—however, the common information should be derivable from each domain's cookie.

Certain embodiments utilise “related” web servers 12a-12c, by which there is a common relationship between each individual web server 12a-12c. For example, each related web server 12a-12c may be “owned” (that is, at least operated) by a common entity but providing different services on the different domains. In one illustrative example, the first domain references a car sale service (e.g. advertising and facilitating sales of cars between individuals and/or companies), the second domain references a non-vehicle property sale service (e.g. an auction service), and the third domain references a content provision service (e.g. a news website). Each of these services is offered by a common entity (e.g. Company A) but under different branding and/or owned companies, and therefore, each service is associated with a unique domain.

In the prior art, third-party cookies are utilised to store common information (e.g. an identifier unique to the particular client device 11, and which may also be unique to the particular web browser and/or user of the web browser) that is then accessed by each web server 12a-12c to enable each service to offer individualised content to the user associated with that identifier, as the third-party cookie is accessible by each separate domain.

One or more embodiments described herein are therefore directed towards providing similar functionality of making accessible the common information while avoiding the use of third-party cookies. Depending on the embodiment and implementation, the manner in which said information is utilised may be left to the particular web servers 12a-12c.

For the purposes of the present disclosure, a cookie set in relation to a particular domain is referred to as a “domain cookie”. Labels such as “first” and “second” are utilised to distinguish between different domains and their associated web servers 12 and domain servers 13. Similarly, common lowercase suffixes are used to identify different features of the figures that are related to a particular domain. For example, a first web server 12a and a first domain server 13a are addressable at a first domain which can be associated with a first domain cookie, a second web server 12b and a second domain server 13b are addressable at a second domain which can be associated with a second domain cookie, and a third web server 12c and a third domain server 13c are addressable at a third domain, which can be associated with a third domain cookie.

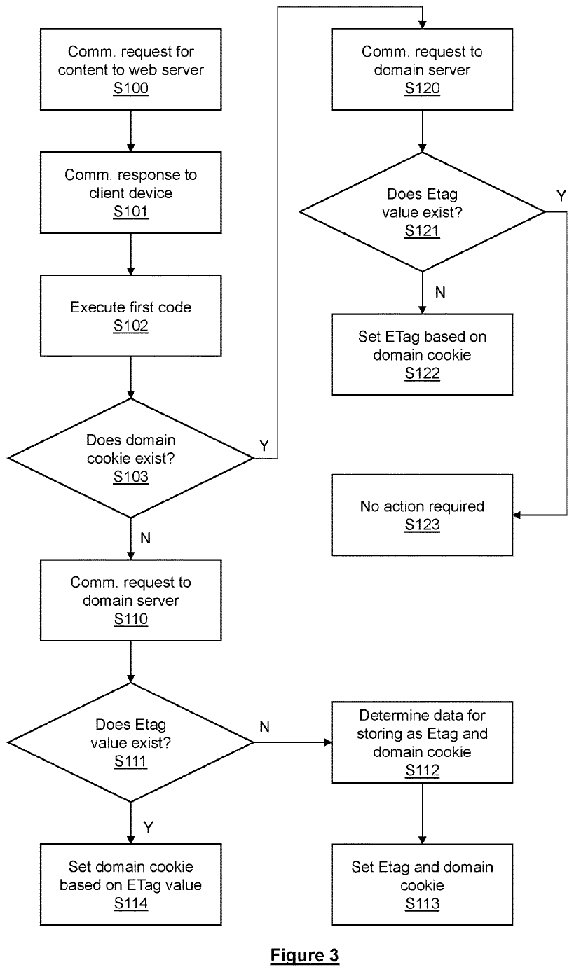

According to an embodiment, with reference to FIGS. 3A and 3B, a method is described relating to setting non-cookie web page specific data within the web browser of a client device 11. One example known in the art is an ETag. The method also describes setting a first domain cookie on the web browser of the client device 11 in relation to a first web page. The first domain cookie is a first-party cookie, in that it is set in association with the same domain as the first web page (first domain), although it is set by the first domain server 13a rather than the first web server 12a. Relevantly, the first domain cookie is accessible by executable code—for example, the first domain cookie does not have the “HttpOnly” attribute set. Relevantly, the web page specific data should be of a form which is not accessible to the code executed on the client device 11—for example, an ETag value is not accessible by JavaScript. It can be preferred that the web page specific data is only accessible to web-based servers such as the web servers 12 and domain servers 13.

At step S100, the client device 11 communicates a request for content to the first web server 12a, which as described above is associated with a first domain (e.g. www.example1.com). The request typically will specify a particular web page for which content is desired—it should be noted that a default web page can be selected (e.g. http://www.example1.com/index.html). At step S101, a response is communicated to the client device 11 from the first web server 12a, the response being determined in accordance with the request. The response comprises a domain server communication instruction (as executable code) for execution by the web browser of the client device 11 (e.g. in the form of JavaScript code) as well as, typically, content for display on the web browser.

The domain server communication instruction is an instruction for the web browser of the client device 11 to communicate with the first domain server 13a. Relevantly, the domain server 13 is present on the same domain as the first web server 12a, although the domain server 13 can be located at a different IP address to the web server 12. In a particular implementation, a subdomain of the first domain is used to address the first domain server 13a (e.g. http://processing.example1.com). Therefore, as discussed above, a first domain cookie set due to communication with the first domain server 13a will be a first-party cookie (due to sharing its domain with the first web server 12a).

Depending on the embodiment, the domain server communication instruction comprises a first executable code configured to cause the web browser to communicate with the first domain server 13a. Alternatively, the domain server communication instruction comprises an instruction for the web browser to obtain the first executable code from the domain server 13a. In either case, as a result of step S101, the web browser is provided with the first executable code.

At step S102, the web browser executes the first code. The first code is configured to undertake a check step S103. Here, the web browser performs a check for a first domain cookie previously stored by the web browser. As previously discussed, the first domain cookie, if present, is accessible to the first code. Relevantly, as discussed, the first domain cookie is associated with the domain of the web page (i.e. the first domain).

If the first domain cookie is not present, then the first code is configured to cause the web browser to communicate a request to the first domain server 13a, at step S110. If available, an ETag value (or, depending on the embodiment, other web page specific data) associated with the web page is communicated with the request (for ETags, if present, the ETag value will be communicated as defined by the HTTP standard).

Next, at step S111, the first domain server 13a is configured, upon receiving the request, to determine whether the ETag value is present with the request.

The presence of the ETag value in this situation (where a first domain cookie is not present) indicates to the first domain server 13a that the web browser has previously accessed a second website (e.g. associated with the second web server 12b), hosted on a different domain (e.g. the second domain) to the first website, and had a second domain cookie set in relation to the second domain by the second domain server 13b (therefore, the second domain cookie is a first-party cookie of the second domain, and therefore not accessible in communications with the first domain server 13a). In this scenario, the first domain server 13a is configured to communicate a reply to the client device 11 setting a domain cookie associated with the first domain with a value derived from (for example, comprising) the ETag value, at step S114. As a result, the web browser stores a “first-party” first domain cookie associated with the first domain which records the same information as the second domain cookie associated with the second domain.

If an ETag value is not present, then the first domain server 13a is configured to determine data for storing in both a first domain cookie and as an ETag value, at step S112, and to send a response to the web browser of the client device 11 instructing it to set both the first domain cookie and the ETag value, at step S113. Regarding step S112, the particular means by which the first domain server 13a determines the data depends on the implementation. However, in one particular example, the data is obtained or derived from the third-party content server 14 (for example, from a set-cookie command issued by the third-party content server 14)—in this case, the first domain cookie and ETag value reflect the information intended for storage obtained from the third-party content server 14. The set-cookie command issued by the third-party content server 14 is effectively an instruction to set a third-party cookie, as the third-party content server 14 is on a different domain to the first domain. In another example, the first domain server 13a is itself configured to determine the data for storing as the first domain cookie and ETag value—it can be, for example, a randomly or procedurally generated identifier or other data for future use by the web servers 12a-12c and/or the domain servers 13a-13c.

Considering now a result of check step S103 where the first domain cookie is present. The first code is configured to, in response, cause the web browser to communicate a request to the first domain server 13a, at step S120. The request is accompanied by the information stored within the first domain cookie (thereby making the information available to the first domain server 13a) and, where available, an ETag value (or, depending on the embodiment, other web page specific data).

At step S121, the first domain server 13a checks whether the request is accompanied by the ETag value.

If the request is not accompanied by an ETag value, then the first domain server 13a communicates a response to the client device 11 comprising a set ETag instruction, where the ETag is set to the value of the first domain cookie (or at least, a value derived from the first domain cookie data), at step S122. In this way, in effect, the web browser has stored the information recorded within the first domain cookie value in the ETag.

On the other hand, if the request is accompanied by an ETag value, then the first domain server 13a can communicate a response to the client device 11 specifying that no update is required to either the ETag or the domain cookie, at step S123. Equivalently, the response can be an instruction to refresh either or both of the ETag value and the first domain cookie (for example, this may be useful where either or both of the ETag and domain cookie have a finite lifetime).

FIG. 3 therefore defines a mechanism by which the data of a first-party domain cookie associated with a one web page can be copied to a first-party domain cookie associated with another web page. Therefore, the data need only be determined once, in relation to the one web page, and then propagated amongst any other web pages associated with other domains. As a result, the method of FIG. 3 provides first-party domain cookies for each different domain recording the same information—in effect therefore, the collection of first-party domain cookies can advantageously provide a similar function as a single third-party cookie.

According to an embodiment, one or more of the related domain cookies are modified with respect to the original information. For example, a domain cookie can be subjected to an anonymisation routine in order to obfuscate the original information. It is preferred that the modification is reversible by the relevant domain server 13—such that, a domain server 13 is accurately enabled to determine the original information from its associated domain cookie. For example, encryption keys can be utilised using, for example, the domain names of the domain cookies such that each domain cookie is associated with different encryption output derived from the same information. In another example, a random prefix and/or suffix of known size (known, that is, to the related domain server 13) is attached.

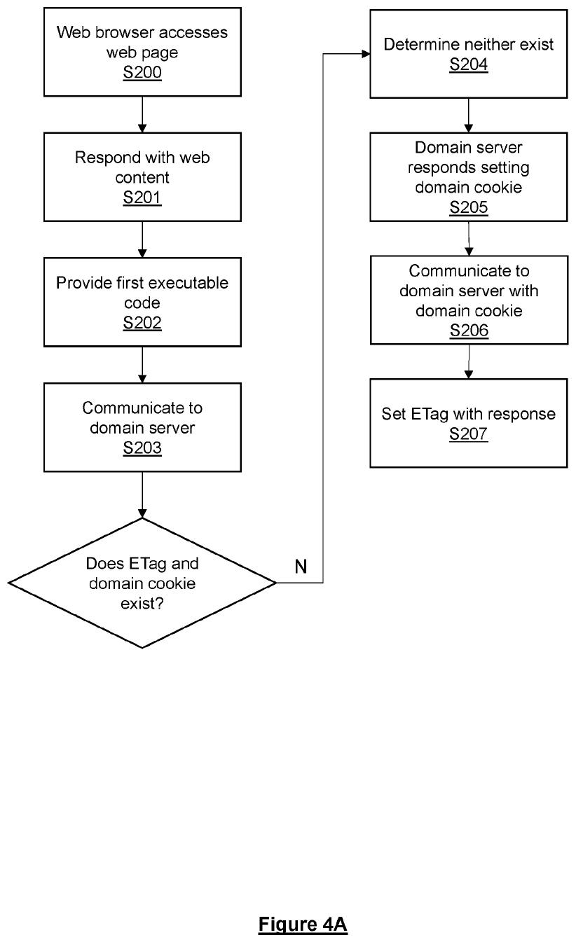

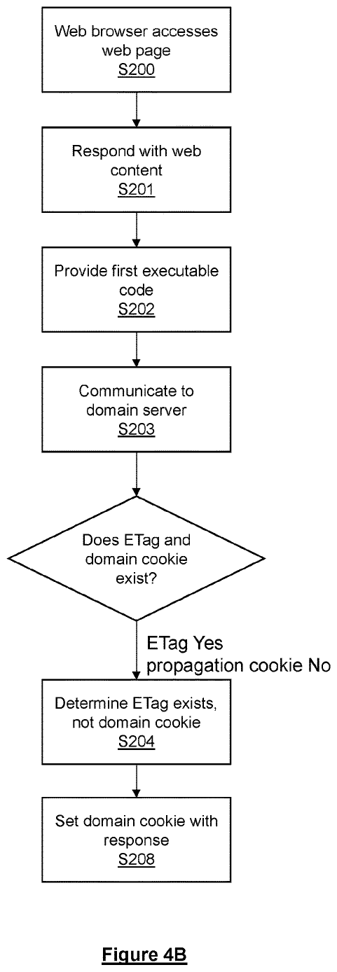

FIGS. 4A and 4B show an example implementation of the embodiment of FIG. 3. At step S200, a user of a web browser on the client device 11 directs the web browser to a first web page hosted by first web server 12a. The first web server 12a returns a response comprising the HTML code defining the content for display on the client device 11, at step S201. The response also comprises first executable code comprising instructions as discussed with reference to FIG. 3, at step S202. Alternatively, the response comprises an instruction to obtain said first executable code from the first domain server 13a, and the web browser obtains the first executable code as a result (again, at step S202).

At step S203, the web browser, due to execution of the first executable code, communicates with the first domain server 13a and communicates, if available, a first domain cookie associated with the first domain server 13a. The first domain server 13a also obtains an ETag value (or more generally, web page specific data which is not accessible to the executable code and is accessible to the first domain server 13a irrespective of which domain server 13 originally set the web page specific data value (i.e. which domain was accessed when the web page specific data was set). For example, the web browser of the client device 11 access a web resource, such as an image, located on the first domain server 13a and, in doing so, communicates an ETag value (if available) to the first domain server 13a associated with the image. The first domain server 13a is therefore configured to identify the ETag value of the particular image. The first domain cookie will be available if previously set by the first domain server 13a due to a previous communication. The ETag will be available if previously set by any one of the domain servers 13 due to a previous communication (e.g. when the image is communicated to the client device 11, an appropriate ETag value (according to embodiments herein described) is set in association with the image.

FIG. 4A shows a situation where neither the first domain cookie nor the ETag are available for communication to the first domain server 13a, determined at step S204. In this case, the method of FIG. 3 results in step S113 (setting a value for the first domain cookie and the ETag). The value for the ETag and the first domain cookie can be generated by the first domain server 13a, the first web server 12a, or a third-party content server 14 (depending on the implementation).

According to this particular example, the first domain cookie (first domain) is set in a first communication, at step S205. The web browser is then configured to communicate again with the first domain server 13a, sending at step S206 a data of the first domain cookie (which is now set due to step S205). Considering the method of FIG. 3, the first domain server 13a will end at step S122—a response is communicated at step S207 to the client device 11 instructing it to set an ETag equivalent to the first domain cookie (first domain). In this sense, the first executable code is essentially run twice—the first execution giving the result of step S113 of FIG. 3 and the second execution giving the result of step S122 of FIG. 3.

FIG. 4B shows a situation where the first domain cookie (first domain) is not available but the ETag is available for communication to the first domain server 13a, determined at step S204. In this case, the method of FIG. 3 results in step S114 (setting a value for the first domain cookie based on the ETag). The implication is that the web browser has visited a web page hosted on a different domain to the current web page, but that utilises a related domain server 13. Therefore, another domain cookie has been set in relation to the different domain and can be utilised for setting a first domain cookie for the first domain.

According to this example, first domain cookie (first domain) is set by a response communicated from the first domain server 13a to the client device 11, at step S208. Further execution of the method of FIG. 3 can occur during the current process but will result in step S123 of FIG. 3—no action required. Again, in this sense, the first executable code can be run twice—the first execution giving the result of step S114 of FIG. 3 and the second execution giving the result of step S123 of FIG. 3.

The embodiment of FIG. 3 (and examples of FIGS. 4A and 4B) therefore utilises non-cookie web page specific data stored on the web browser of a client device 11 to effectively “signal” whether another domain cookie for another related domain is present, when a web page of a first domain is accessed.

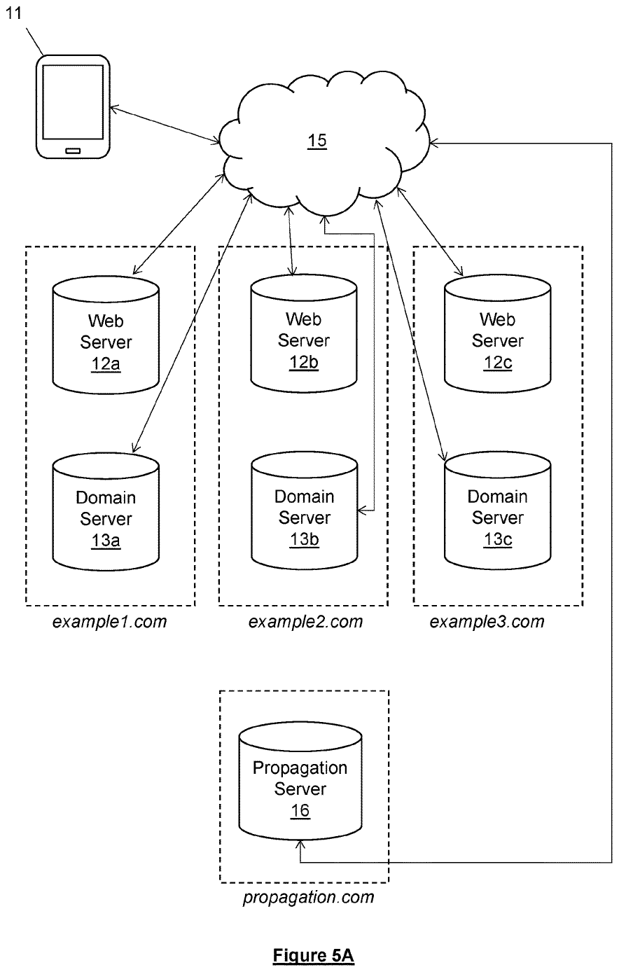

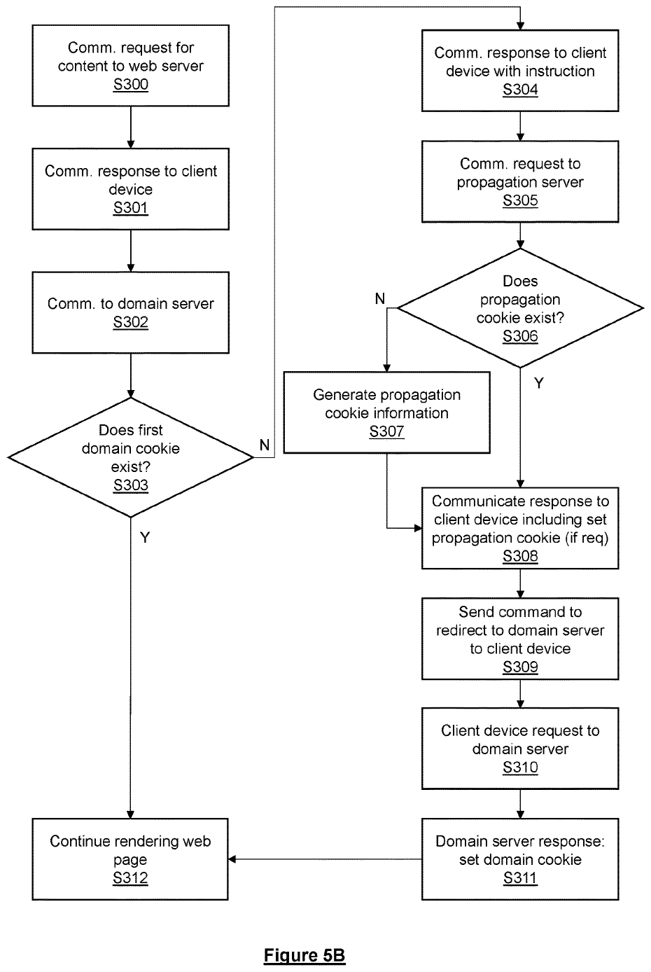

According to an embodiment, a propagation server 16 is associated with a propagator domain (e.g. www.exampleserver.com), as shown in FIG. 5A. The propagation server 16 is configured to facilitate propagation of cookie information among domain cookies, which are each associated with one of a plurality of domain servers 13a-13c—that is, the propagation server 16 can facilitate an exchange data with each domain server 13a-13c. The propagation server 16 is in data communication with the network 15. It is possible that one or more of the domain servers 13 can be embodied as a logical function of the propagation server 16, although it may be preferred that each domain server 13 is logically and/or physically distinct to the propagation server 16. Also shown in FIG. 5A is a plurality of web servers 12a-12c. As with FIG. 1, a representative client device 11 is also shown in communication with the network 15; therefore, client device 11 is enabled to communicate with each web server 12a-12c, each domain server 13a-13c, and the propagation server 16, via said network 15. Relevantly, each domain server 13a-13c is addressable at a respective domain as one of the web servers 12a-12c as described above.

In an implementation, each domain server 13 is addressable via a subdomain of its associated domain. The subdomains can be labelled as desired, it is relevant that each is resolvable to the network address (e.g. IP address and optionally TCP or UDP port number) of the associated domain server 13. Each domain server 13 can be located at the same or different IP address to its associated web server 12, depending on the implementation.

FIG. 5B shows a method relating to setting a first domain cookie associated with the first domain and therefore accessible to the first web server 12a and the first domain server 13a, in dependence on the presence and value of a common cookie (“propagation cookie”) associated with the propagator domain. The common cookie can be, for example, an identifier associated with the particular client device 11 (in this case, referred to herein as a “userID”).

At step S300, the client device 11 communicates a request for content to first web server 12a. The request typically will specify a particular web page for which content is desired—it should be noted that a default web page can be selected (e.g. http://www.example1.com/index.html). At step S301, a response is communicated to the client device 11 from the first web server 12a, the response being determined in accordance with the request. The response comprises a domain server communication instruction (as executable code) for execution by the web browser of the client device 11 (e.g. in the form of JavaScript code), configured to cause the client device 11 to communicate to the first domain server 13a. The response also, typically, comprises content for display on the web browser. Alternatively, or in addition, the first web server 12a can send a redirect instruction (e.g. via location headers in the response) to the first domain server 13a.

At step S303, the first domain server 13a receives the communication from the client device 11 and analyses the content to determine if a previously set first domain cookie is present (typically in headers in the case of HTTP).

In a case where a first domain cookie is present (e.g. cookie propagation is not required), the method simply proceeds to web-page rendering step S312 (discussed below), which can be effected by the first domain server 13a communicating an instruction to the client device 11 to undertake a further communication to the first web server 12a.

In a case where a first domain cookie is not present (e.g. cookie propagation or initial creation is required), the first domain server 13a communicates a response to the client device 11 from the first web server 12a, at step S304. The response comprises a propagation server communication instruction (e.g. as executable code) for execution by the web browser of the client device 11 (e.g. in the form of JavaScript code), configured to cause the client device 11 to communicate to the propagation server 16. Alternatively, or in addition, the first domain server 13a can send a redirect instruction (e.g. via location headers in the response) to the propagation server 16. In response, the client device 11 communicates a request to the propagation server 16 at step S305, the request optionally including information identifying the first domain server 13a (for example, information can be passed in a URL or via a suitable network protocol).

At step S306, the propagation server 16 receives the communication from the client device 11 and analyses the content to determine if a propagation cookie is present (typically in headers in the case of HTTP), at step S305. The presence of a propagation cookie indicates that the client device 11 has previously visited a related domain (e.g. the second or third domain) resulting in a domain cookie (e.g. second domain cookie or third domain cookie, etc.) being set in relation to the related domain. The absence of a propagation cookie indicates that the client device 11 has not previously visited a related domain and had a domain cookie set for the related domain.

In a case where a propagation cookie is not present, at step S307, the propagation server 16 is configured to determine information for recording within a new propagation cookie on the client device 11. The information can be randomly generated or procedurally generated, or alternatively, generated via a communication with a third-party content server 14 (not shown in FIG. 5B).

In either case, the propagation server 16 communicates a response to the client device 11, at step S308. The response comprises a domain server communication instruction (e.g. as executable code) for execution by the web browser of the client device 11 (e.g. in the form of JavaScript code), configured to cause the client device 11 to communicate to the original domain server 13 (i.e. in this example, the first domain server 13a), at step S309. Alternatively, or in addition, the propagation server 16 can directly effect a redirect (e.g. via location headers in the response) to the first domain server 13.

In the case that step S307 is performed, the response also comprises a set propagation cookie command to cause the client device 11 to set a propagator associated with the propagator domain recording the generated information.

In response, the client device 11 then communicates a request to the first domain server 13a, at step S310. In response to the request, at step S311, the first domain server 13a is configured to determine the information recorded in the propagation cookie and communicates a response to the client device 11 comprising a set cookie command to cause the client device 11 to set a first domain cookie associated with the first domain recording the information.

In an embodiment, the domain server 13a obtains the information from the web browser of the client device 11. For example, the domain server communication instruction of step S308 includes the information recorded in the propagation cookie and is configured to cause the web browser of the client device 11 to communicate the information (which is preferably encrypted) to the first domain server 13a. For example, the information can be passed in a URL or via a suitable network protocol. Here, the client device 11 is effectively utilised as an intermediary, which may advantageously allow for method to avoid direct communications between the propagation server 16 and the domain servers 13—this may provide for improved privacy and/or security (or at least a perception of an improvement).

In an alternative embodiment, the propagation server 16 is configured to identify the first domain server 13a (more generally, the particular domain server 13 which initiated the client device 11 communication to the propagation server 16, derivable from the request received by the propagation server 16) and to communicate the generated or previously recorded information for the propagation cookie (or, at least, data derived from the recorded information) to the first domain server 13a along with, typically, information identifying the particular client device 11.

The response also comprises a web server communication instruction (e.g. as executable code) for execution by the web browser of the client device 11 (e.g. in the form of JavaScript code), configured to cause the client device 11 to communicate to the original web server 12 (i.e. in this example, the first web server 12a). Alternatively, or in addition, the first domain server 13a can send a redirect instruction (e.g. via Location headers in the response) to the first web server 12a.

In an embodiment, one or more of the domain servers 13 are implemented as functions executed by the corresponding web server 12 (i.e. the web server 12 sharing the same domain). In these cases, the domain servers 13 described herein should be understood in terms of their functional steps, for example, the setting and reading of domain cookies and the communication and reception from the propagation server 16 of recorded information (or derived data). In this case, it may be unnecessary to explicitly communicate a web server communication instruction to the web browser.

The method then proceeds to web page rendering step S312 (which can also be arrived at after step S303). At this step, the first web server 12a communicates with the client device 11 (which may comprise multiple separate instances of communication) and can utilise the content of the first domain cookie to generated personalised content—the first domain cookie is accessible to the first web server 12a due to it sharing the first domain with the first domain server 13a.

Accordingly, the method of FIG. 5B can be utilised to effectively propagate cookies (or more generally, the information recorded in a cookie can be propagated amongst different domain cookies) across the various web servers 12a-12c. The propagation cookie is utilised to signal to the propagation server 16 whether or not (through its presence or absence) a client device accessing a particular web server 12 has previously visited another related web server 12 on another domain and, therefore, previously generated information intended to be commonly available to the plurality of related web servers 12 (e.g. all web servers 12a-12c). For example, the information can be a UserID suitable for identifying that the particular client device 11 (or a particular user of said client device 11) has previously visited related websites on different domains. In the case of the information recoded in the propagation cookie being an identifier such as a UserID, the domain cookies can record the UserID or information derived from the UserID as DomainIDs (that is, each DomainID is for the particular domain, but are related in a manner that enables identification of the user). Therefore, the collection of domain cookies having related DomainIDs can be utilised by the related web servers 12 to generate personalised information for the client device 11. The direct communication between the domain servers 13 and the propagation server 16 enables the effective propagation.

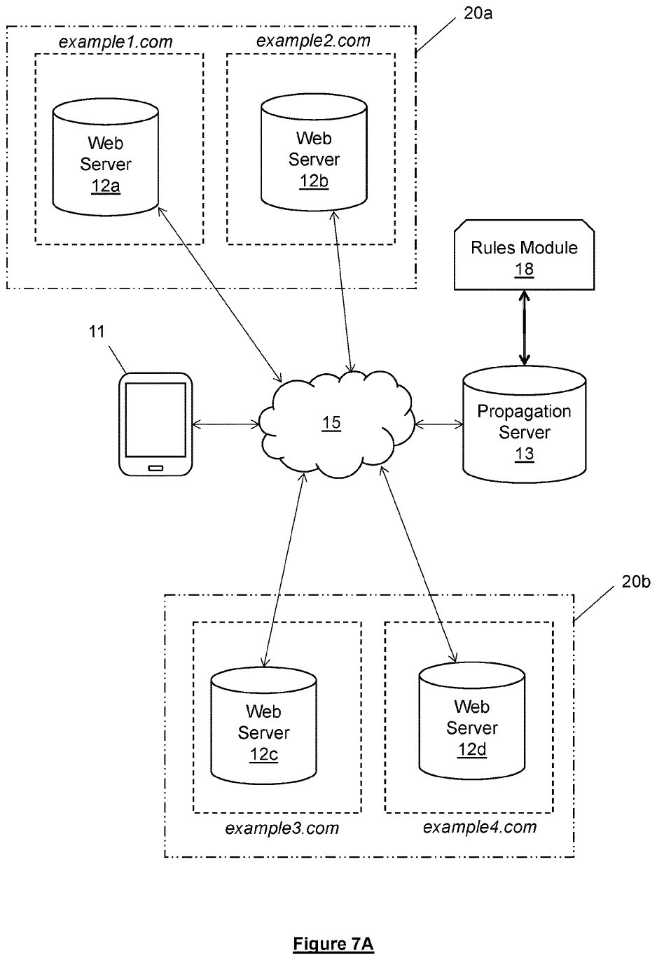

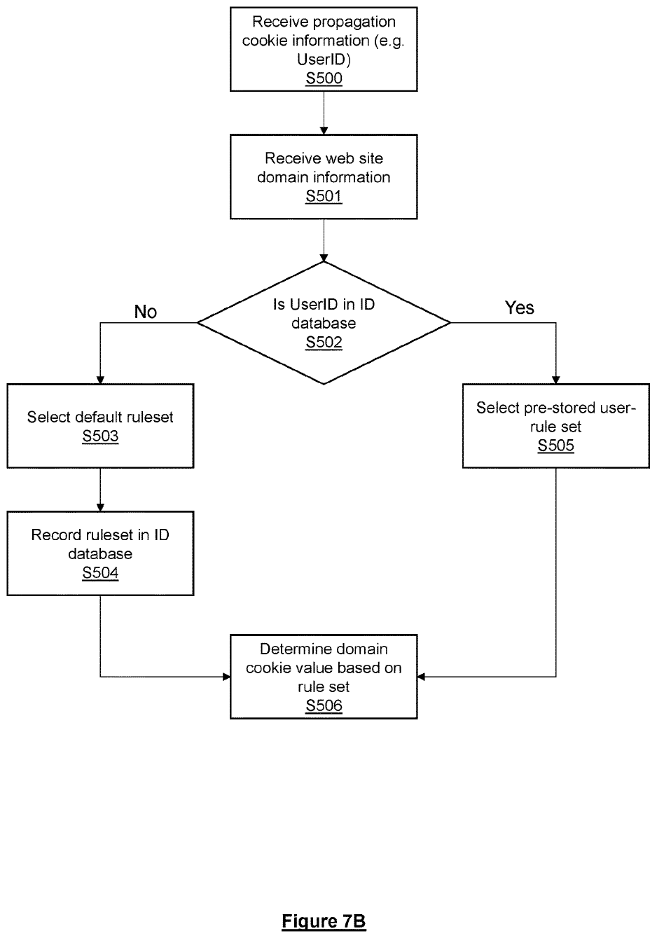

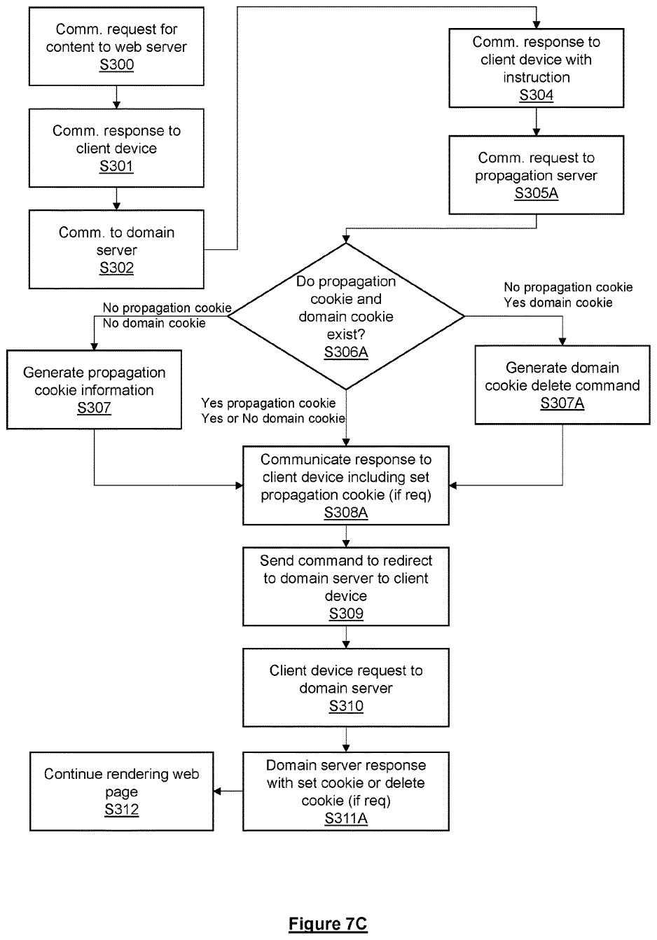

According to an embodiment, with reference to FIGS. 7A-7C, the propagation server 16 is interfaced with a rules module 18 (see FIG. 7A). The rules module 18 can be a logical function of the propagation server 16 (assumed herein) or can be implemented as a different physical or logical server in data communication with the propagation server 16. Also shown are four web servers 12a-12d, where web servers 12a, 12b are associated with a first group 20a and web servers 12c and 12d are associated with a second group 20b. Although web servers 12 can be grouped according to any particular relationship, for the present purposes, it is assumed that the first group 20a comprises web servers 12a, 12b of domains administered (e.g. owned) by a first entity and that second first group 20b comprises web servers 12c, 12d of domains administered (e.g. owned) by a second entity, different to the first. Relevantly, according to the present embodiment, propagation server 16 is configured to manage cookie propagation for all web servers 12a-12d (more generally, web servers 12 belonging to different groups 20).

The rules module 18 is configured to apply propagation rules before communication of a response comprising a domain cookie to a client device 11 and/or domain server 13 (depending on the embodiment). The propagation rules are used to determine whether a domain cookie is set and, if so, with what specific data (for example, the specific data can record common information to other domain cookies and/or the propagation cookie in a different format, for example, due to unique encryption which may be associated with the particular domain).

In an embodiment, at least a portion of the propagation rules for use in generating data for a particular domain cookie is stored in the associated propagation cookie itself—these are referred to herein as user-set propagation rules. The user set propagation rules in this embodiment are stored in the user's web browser which may advantageously avoid a central location of the user-set propagation rules of a number of different users. In this embodiment, the user-set propagation rules are preferably recorded in an encrypted form such that a direct read of the propagation cookie does not reveal the user-set propagation rules stored in that propagation cookie.

In an embodiment, the rules module 18 is alternatively or also configured to maintain a data structure identifying known (that is, previously determined) propagation cookies and related information—for example, as a database (herein, “ID Database”). The data structure can be updated as new propagation cookies are determined and as the related information is changed. The related information includes, for each user, user-set propagation rules (which may be default or customised).

In an embodiment, at least a portion of the propagation rules are set by the propagation server 16 (more generally, an operator of the propagation server 16)—these are referred to herein as system-set propagation rules. For example, the definition of groups 20 can be understood as system-set propagation rules. In an embodiment, at least a subset of user-set propagation rules can override contradictory system-set propagation rules and/or at least a subset of system-set propagation rules can override contradictory user-set propagation rules

FIG. 7B shows a method for determining a response by the propagation server 16, according to an embodiment. The method of FIG. 7B assumes that there is already a propagation cookie associated with the particular client device 11 (or more particularly, a web browser of the client device 11)—that is, the web browser has previously visited any one of the web servers 12 irrespective of group 20 or a propagation cookie is newly generated prior to implementing FIG. 7B. The propagation cookie effectively represents a user (or, a particular client device 11 or web browser on a particular client device 11) and can be considered, therefore, an identifier. Therefore, for the purpose of exposition, the content of a particular propagation cookie includes a record of a UserID.

In an embodiment, the method of FIG. 7B is performed as part of step S308 of FIG. 5B. In this case, the propagation server 16 is configured to differentiate the information that is stored in the propagation cookie to that which is stored in the domain cookie(s).

At step S500, the rules module 18 receives the information recoded in the propagation cookie (here assumed to be the UserID), and at step S501, receives information identifying the domain of the web server 12 being accessed by the client device 11 (this information can be provided simultaneously).

The rules module 18 then determines the particular user-set propagation rules associated with the user (or, more specifically, the propagation cookie) at step S502. For example, depending on the embodiment, the rules module 18 can obtain the user-set propagation rules from the actual propagation cookie.

In another embodiment, the rules module 18 compares the UserID to the records of the ID database to check if the UserID has previously been stored in the ID database. As with other embodiments, the UserID may be stored in a derived format within the actual propagation cookie, for example, through use of an encryption algorithm. Relevantly, the UserID is derivable from the propagation cookie.

If the rule module 18 cannot determine particular user-set propagation rules (e.g. depending on embodiment, not stored in the propagation cookie or does not exist within ID database), the method proceeds to step S503, where the rules module 18 determines and selects a default ruleset to use as the user-set propagation rules at subsequent step S506. There may be a single default ruleset or there may be a plurality of default rulesets, the rules module 18 being configured to determine one of said default rulesets as appropriate (for example, based on the relevant domain, information about the client device 11, or other factors).

Optionally, at step S504, the rules module 18 stores the selected ruleset as the user-set propagation rules associated with the propagation cookie. For example, in an embodiment, the user-set propagation rules can be set as content of the propagation cookie by setting or updating the propagation cookie on the client device 11. For an embodiment where an ID database is utilised, the rules module 18 stores the selected ruleset within its ID database reference to the propagation cookie information along with a user-specific ruleset which can be simply the same as the selected default ruleset. The user, however, may be provided an option during the method of FIG. 7B, for example by a website redirect or a “pop-up”, to customise the default ruleset before it is recorded as user-specific propagation rules.

On the other hand, if the user-set propagation rules do exist within the propagation cookie or the ID database (as applicable), the method proceeds to step S505, in which the rules module 18 obtains these stored user-set propagation rules. The method then proceeds to step S506.

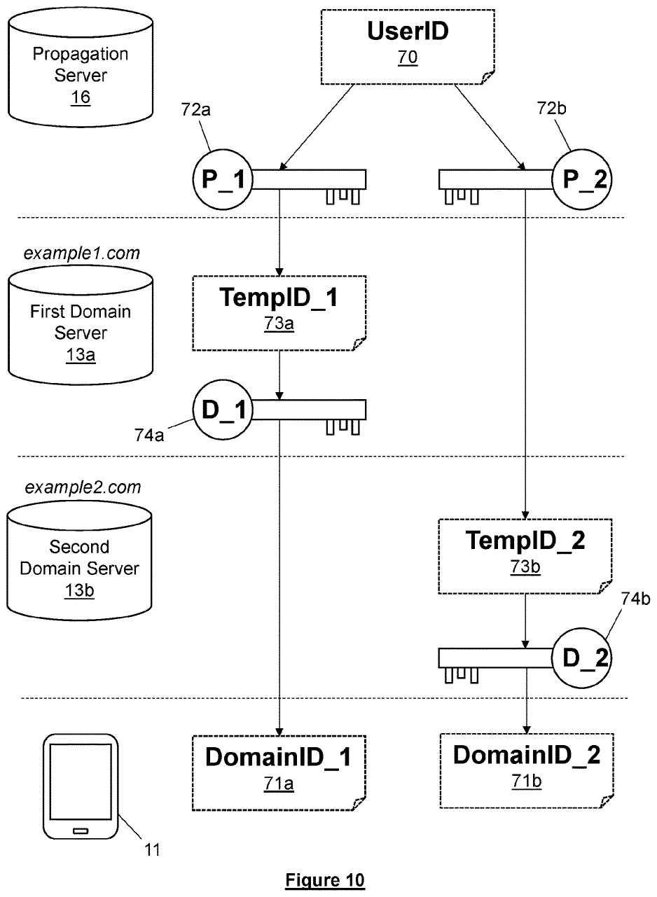

FIG. 9 shows an example of a user control interface 30 utilised in an embodiment. The user control interface 30 can correspond to a pop-up presented on the web browser to enable the user to, in effect, configure the user's preferences for the user-set propagation rules. Other techniques can be utilised instead of a pop-up; for example, the web browser can be directed to a web page associated with the propagation domain. It should be understood that the user control interface 30 can correspond to multiple “pages” which the user can move between (e.g. as separate menu elements).

Generally, the user control interface 30 enables modification of the user-set propagation rules stored on the web browser through interaction with the propagation server 16. In the example shown, the user control interface 30 comprises a propagation rules section 31. The propagation rules section 31 enables the user to set preferred user-set propagation rules. In the example, shown, the propagation rules section 31 enables setting of which domains the user authorises tracking for—thus, in this example, when the user visits example1.com, in effect, the corresponding web server 12 will ultimately receive a random, anonymous DomainID (or, equivalently, no DomainID) rather than one generated in dependence on the user's UserID, as the user has selected no tracking. In contrast, when the user visits any one of example2.com, example3.com, and example4.com, the corresponding web servers 12 will receive a corresponding DomainID that is generated in dependence on the user's UserID, as the user has authorised tracking. Generally, the propagation rules section 31 comprises means for the user to set which user-set propagation rules are available.

In some embodiments, a user data section 32 is also provided. The user data section 32 allows a user to enter optional information which can assist in the provision of content to the user, but do not constitute a user-set propagation rules. For example, as shown, this can include personal user information such as name, email address, age, gender, and others. In an implementation, the user can select an anonymous email address as an alternative to providing their own address. Also shown in the example is advertising preference information, such as categories of interest to the user. The user data section 32 therefore constitutes additional information, which is typically stored in the user's web browser in combination with domain cookies, and which can be provided to web servers 12 to assist with providing customised content to users.

In an embodiment, the user control interface 30 is associated with the client device 11 communicating with the propagation server 16, for example, as part of step S307. The user can be enabled to utilise the user control interface 30 separately to steps related to the propagation of recorded information. For example, the user can access the user control interface 30 through visiting a website known to provide such service, which can be hosted on the same domain as the propagation server 16. The user control interface 30 represents content delivered by (or, more generally, communications with) the propagation server 16 rather than a web server 12. In an implementation, the user control interface 30 can comprise a web browser settings interface separate to the web browser interface itself—for example, accessible via a menu of the web browser. In this case, the web browser settings interface undertakes data communications with the propagation server 16 in order to cause modifications to the propagation rules stored on the web browser.

In an embodiment, the user control interface 30 is automatically generated in an instance where a propagation cookie is created due to the web browser's interaction with the system 10, to enable the user to set their preferred rules to begin with. In an embodiment, the user control interface 30 is automatically generated in an instance where a new domain cookie (i.e. whether or not a propagation cookie already is present) is created due to the web browser's interaction with the system 10. Although the user control interface 30 can be presented to the user in each instance of a client device 11 communicating with the propagation server 16 or a web server 12 of the system 10, this may be undesirable due to having an adverse effect on the user's web browsing experience. In an embodiment, therefore, a relatively small and discrete initial popup (not shown) can be presented to the user requesting whether the user would like to edit their preferences (in effect, edit the propagation rules associated with their web browser). The user can then be enabled to interact with the initial popup such as to indicate an intention to edit the propagation rules, in which case, the user control interface 30 is presented to the user (e.g. via a suitable direction to the client device 11 to communicate with the propagation server 16). The user ignoring said initial popup can be interpreted as the user indicating that they do not intend to edit the user-set propagation rules—i.e. default user-set propagation rules will be associated with the user.

In an implementation, the user control interface 30 and/or initial popup include visual information 33 identifying an operator of the propagation server 16, which can beneficially enable the user to understand that the propagation server 16 is operated by an entity separate to the of the web servers 12.

At step S506, the rules module 18 applies the selected ruleset to determine a value for the domain cookie (DomainID) for communication to the relevant domain server 13 (e.g. as used by step S308 of FIG. 5B). Relevantly, the DomainID stored in the domain cookie can be different to the UserID. It should also be understood that, in an embodiment, the rules module 18 can determine to not set a DomainID if the ruleset results in this determination—that is, no domain cookie is generated as a result of the embodiment.

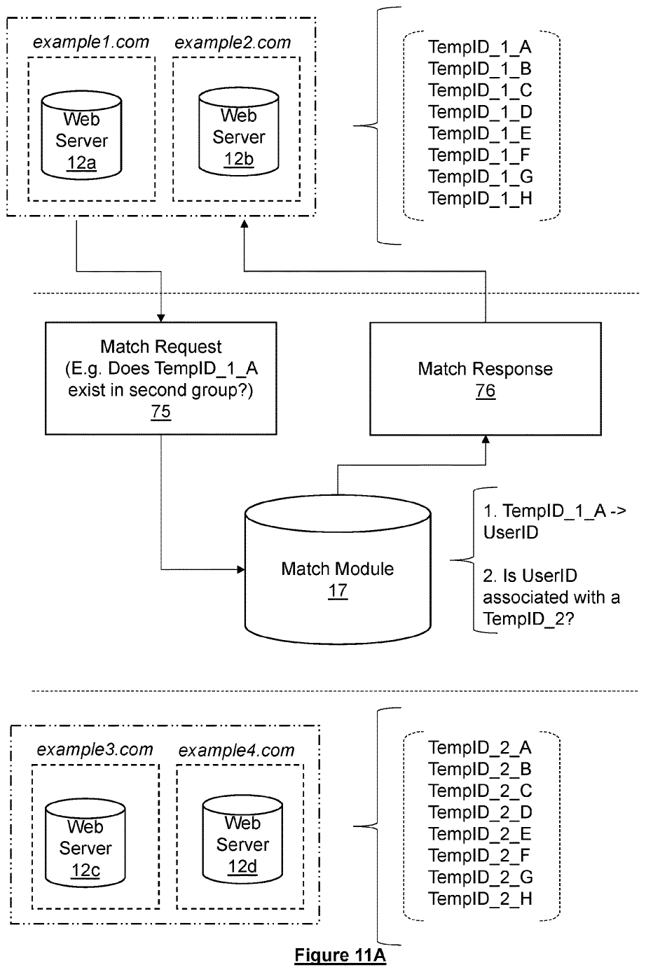

In an embodiment, with further reference to FIG. 10, a particular DomainID value (Domain ID 71a) is generated through at least twice encrypting the corresponding particular UserID 70. The propagation server 13 is arranged to store domain-specific “propagation keys” 72 for each domain. For example, a first propagation key 72a is stored in association with first domain example1.com and a second propagation key 72b is stored in association with second domain example2.com. It is assumed that the first propagation key is different to the second propagation key such that the same encryption algorithm applied to the UserID 70 will result in a different output when using the first propagation key to that when using the second propagation key.

According to this embodiment, the UserID 70 is first encrypted (using a predefined encryption algorithm) using the relevant propagation key. Generally, this is typically performed by the propagation server 13; for example, it can be preferred that it is not performed by the corresponding web server 12 of the domain, which is effected by not providing the propagation key to the web server 12. Therefore, a temporary ID value (TempID 73) is generated by the propagation server 13. The figure illustrates this relationship, showing first TempID 73a (due to a visit to a website of the first domain) as being generated by encrypting the common UserID 70 using the first propagation key 72a. Similarly, second TempID 73b (due to a visit to a website of the second domain) as being generated by encrypting the same UserID 70 but using the second propagation key 72b (which is assumed to be different to the first propagation key 72a). Therefore, the first TempID 73a is different to the second TempID 73b, and both are different to the UserID 70.

The resulting TempID 73 is then further encrypted using a domain-specific “domain key” 74. Advantageously, the domain keys 74 are not required to be stored on the propagation server 13. Therefore, in an embodiment, the operators of the relevant domains can set their respective domain keys 74 without requiring they domain keys 74 to be made known to the propagation server 13. Therefore, TempIDs 73 are encrypted using domain keys to generate the DomainIDs 71. Encryption is performed by the relevant domain server 13. A DomainID 71, once generated, is then stored on the client device 11 (i.e. encryption is performed before step S311).

FIG. 10 shows first DomainID 71 (due to a visit to a website of the first domain) being generated by encrypting the first TempID 73a using the first domain key 74a. Similarly, second DomainID 71b (due to a visit to a website of the second domain) is shown being generated by encrypting the second TempID 73b using the second propagation key 72b. Therefore, the first DomainID 71a is different to the second DomainID 73b, and both are different to each of the Tempos 73 and to the UserID 70. The result of the methodology of FIG. 10 are a set of unique DomainIDs 71 which are related, via encryption techniques, to a common UserID 70.

An advantage of this embodiment may be that different DomainIDs 71 for the same client device 11 cannot be correlated without access to both the propagation keys and domain keys for the various associated domains. The propagation server 16 is enabled to determine the UserID 70 associated with a particular user (e.g. associated with a specific web browser or specific client device 11) and the TempIDs 73 for various domains but is not enabled to determine the DomainIDs 71 (as it does not hold the domain keys 74). Said another way, the propagation server 16 cannot, itself, determine a DomainID 71 from a supplied UserID 70 (or vice versa). The domain servers 13 are enabled to determine their respective DomainIDs 71 for a particular user (e.g. associated with a specific web browser or specific client device 11) and their respective TempIDs 73, but the domain servers 13 are not enabled to determine the common UserID (as the domain servers 13 do not hold the propagation keys 72).

Regarding the TempIDs 73, according to an embodiment, it is not required that these are stored permanently as both the propagation server 16 (via the propagation keys 72 applied to the UserID) and the domain servers 13 (via the domain keys 74 applied to the respective DomainIDs 71) can determine the TempIDs 73 on an as-needed basis. The TempIDs 73 therefore represent an interim encrypted value between the UserIDs 70 and the DomainIDs 71.

In a variation, the propagation keys 72 are stored on their associated domain servers 13 such that the domain servers 13 perform both encryption steps. Although this enables a particular domain server 13 to determine the common UserID 70 from an associated DomainID 71 of the same domain, domain servers 13 are still barred from determining DomainIDs 71 of other domain servers 13 (i.e. associated with different domains). For example, with reference to FIG. 10, the first domain server 31a can determine the UserID 70 from the first DomainID 71a but it cannot determine the second DomainID 71b.

In an implementation, the propagation rules are configured to identify domain(s) for which cookie propagation is allowed and domain(s) for which cookie propagation is not allowed. For example, user-set propagation rules may define certain domain(s) for which the user has agreed to allow cookie propagation and/or certain domain(s) for which the user has not agreed to allow cookie propagation.

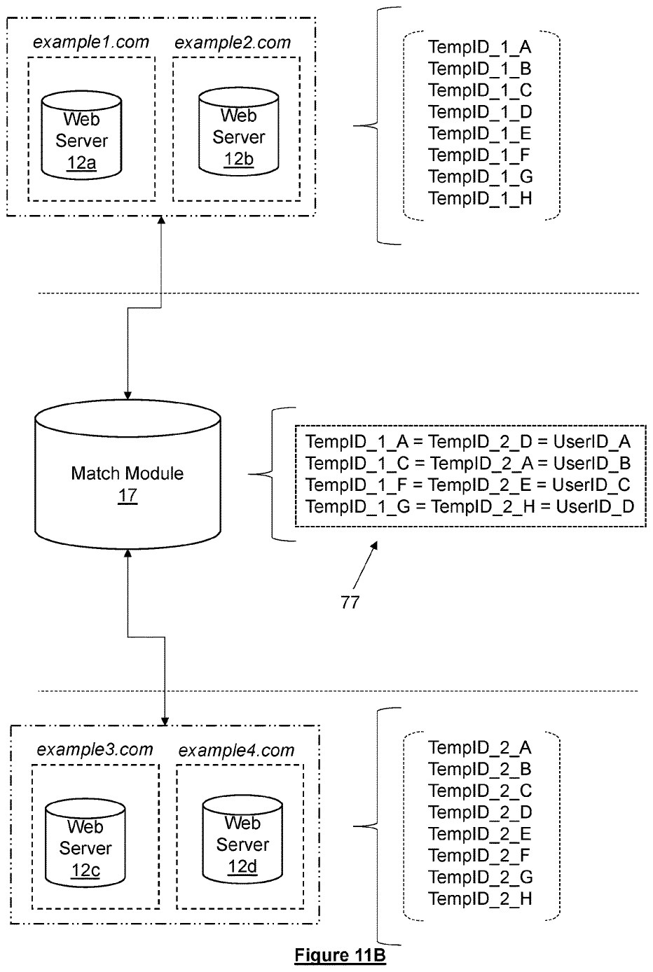

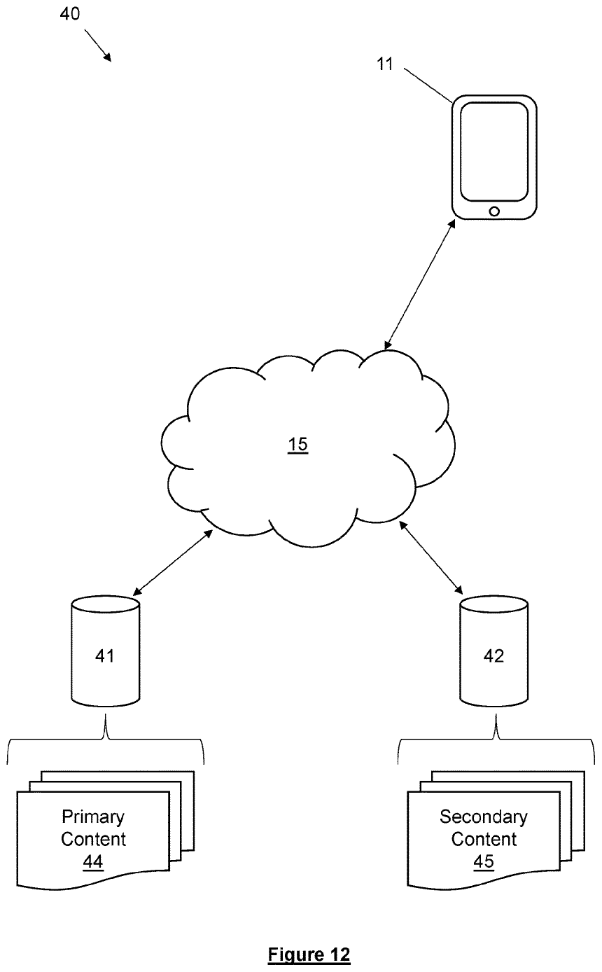

A user of a client device 11 for which a propagation cookie has been generated can, in an embodiment, access a user control interface 30 (or other interface) associated with the particular propagation cookie in order to set specific domains as not allowed or allowed for propagation of the recorded information (e.g. UserID), which can be defined in the user-set propagation rules. Similarly, the user may be enabled to allow or disallow categories of domains (e.g. all sales domains, all news domains, etc.). The user control interface 30 can be provided as a web site associated with the propagation server 16 (either directly hosted on the propagation server 16 or via a separate web server (not shown)). For example, user control interface 30 includes a valid domains category which enables the user to select which domains of a particular group 20 the user allows the UserID to be propagated amongst. That is, although all domains of the group 20 are related commercially, the user is still empowered to control cross-domain use of the common UserID. Another example, the user control interface 30 includes a valid cross-domain category which enables the user to select which groups 20 can share information with one another (this may be limited to embodiments utilising a match module 17—discussed below with reference to FIGS. 11A and 11B).

Referring back to the groups 20 shown in FIG. 7A, in an embodiment, the rules module 18 is further configured to determine the domain cookie based on the particular domain being accessed by the client device 11. For example, the first group 20a can be associated with a first-group domain cookie and the second group 20b with a second-group domain cookie—the particular domain cookie generated therefore depends on the particular group 20. In this example, the domain cookie is set with the value of the first-group domain cookie if the client device 11 is communicating with web server 12a or 12b and with the value of the second-group domain cookie if the client device 11 is communicating with web server 12c or 12d.

This embodiment may be advantageous where the propagation server 16 and domain servers 13 are provided as part of a service by a service provider for a number of different entities (and therefore, groups 20). Accordingly, “cookies” (rather, the information therein contained) are propagated, in effect, only amongst domains of a particular group 20—thus, one entity is not provided with the cookie information (e.g. UserID or derived information such as DomainIDs) associated with another entity in a different group 20. This embodiment may also be advantageous when combined with user control (e.g. via a user control interface 30) of the user-specific ruleset, as the user is given control over a number of different groups 20 of related domains. For example, if a user selects a category of website to disallow propagation, this selection applies across many different entities. For example, if a user disallows propagation amongst “news websites”, this could apply to the news websites of entity A and the news websites of entity B.

It is also expected that certain implementations will enable a user to agree to have a common domain cookie over two or more groups 20, although it is likely that such cross-group propagation will generally be disallowed by default.

The method of FIG. 7B may be suitable to be performed as part of step S113 or S114 of FIG. 3—that is, when determining the domain cookie to be set on the client device 11. This latter case requires separation between the value of the web page specific data (e.g. ETag) and the domain cookie, where the ETag may take the role of the propagation cookie.

In an embodiment, a previously set domain cookie for a particular domain is modifiable. For example, a user which previously allowed propagation to the particular domain may change to disallow use of the UserID derived information for that domain. Similarly, the user may decide to cancel or delete all reference to the UserID and DomainIDs—the cookies on the client device 11 should be updated to reflect this.

FIG. 7C shows a modification to the method of FIG. 5B—previously described and unchanged steps are as per the previous discussion herein. Modified steps are represented with a “A” suffix. Step S302 always proceeds to step S304—if a domain cookie is identified, then at step S305A, the information indicating the presence of the domain cookie is communicated to the propagation server 16. This can be effected by the propagation server communication instruction causing the client device 11 to communicate the information as part of the request, for example, the information can be passed in a URL or via a suitable network protocol. In an embodiment, the client device 11 communicates a flag indicating the presence of the domain cookie (for example, if the presence of the domain cookie is relevant but the actual content is not relevant for the propagation server 16 to determine to proceed to modified step S306A).

Modified step S306A checks whether the propagation cookie and domain cookie are present on the client device 11. However, the propagation server 16 undertakes a predefined action upon determining that the propagation cookie and the domain cookie are both not present. In an implementation, the absence of the propagation cookie is taken to mean the user no longer intends for the information to be available at all—effectively, that a “delete cookie” command should be propagated.

Therefore, at step S307A, the propagation server 16 generates a delete domain cookie instruction which is included within the domain server communication instruction (e.g. as executable code for execution by the web browser of the client device 11) communicated at step S308A, configured to cause the client device 11 to communicate to the original domain server 13 (i.e. in this example, the first domain server 13a). Alternatively, or in addition, the propagation server 16 can directly effect a redirect (e.g. via location headers in the response) to the first domain server S163. The domain server communication instruction includes an instruction, understandable by the domain server 13, to delete the domain cookie.

In response, the client device 11 then communicates a request to the first domain server 13a, at step S310. In response to the request, at step S311, the first domain server 13a is configured to respond, at step S311A, to the client device 11 with a delete cookie instruction to delete the domain cookie (or, in another implementation, to set it to a null or random value) based on the instruction included within the domain server communication instruction, thereby effectively removing the propagated information.

The response also includes a web server communication instruction (e.g. as executable code) for execution by the web browser of the client device 11 (e.g. in the form of JavaScript code), configured to cause the client device 11 to communicate to the original web server 12 (i.e. in this example, the first web server 12a). Alternatively, or in addition, the first domain server 13a can send a redirect instruction (e.g. via location headers in the response) to the first web server 12a.

The method then proceeds to web page rendering step S312. At this step, the first web server 12a communicates with the client device 11 (which may comprise multiple separate instances of communication), however, the generated content is not based on the information which had previously been stored in the first domain cookie.

Regarding FIG. 7C, it should be noted that in a case that both the propagation cookie and the domain cookie are present, the propagation server 16 can either proceed by effectively resetting the domain cookie and/or propagation cookie with their same values or by not sending cookie set commands.

The method can also be modified in relation to the case where the first domain cookie does exist. In this case, the propagation server 16 checks whether the first domain cookie comprises data consistent with a current propagation rules. If the first domain cookie information is inconsistent with the information of the propagation cookie (the comparison involving an application of the propagation rules), the propagation server 16 is configured to determine an update to the first domain cookie. For example, if the user has disallowed propagation for the associated domain, the propagation server 16 can communicate a delete cookie command to the web browser of the client device 11, thereby deleting the domain cookie. If the value for the domain cookie should be changed, this can also be communicated as a new set domain cookie (equivalent to overwrite) command.

The embodiments described with reference to FIGS. 7A-7C may advantageously provide for a balance between privacy, by allowing a user to choose domains to allow cookie propagation (or otherwise disallow and/or limit), and e-commerce functionality, by enabling content providers to provide tailored content based on consistently identifying a particular user.

FIG. 11A illustrates an embodiment comprising a match module 17 configured to enable limited information regarding a user to be made available between different groups 20. Relevantly, groups 20 are not provided with the DomainIDs of other groups 20—instead, the match module 17 facilitates the exchange of limited information. For example, the information may comprise simply a “yes/no” as to whether a first DomainID of a first group 20a (DomainID_1 in the figure) shares the same UserID as a second DomainID of a second group 20b (DomainID_2 in the figure). In effect, has the same user previously visited both groups. The information can comprise additional information, such as, which domains of a group 20 have been visited by the user. In an embodiment, the match module 17 is implemented by the propagation server 16. In another embodiment, the match module 17 is implemented by a match server (not shown). In either case, the match module 17 has access to the propagation keys known to the propagation server 16.

In an embodiment, the match module 17 receives a match request from the first group 20a (e.g. this may be a particular web server 12 of the first group 20a) identifying one or more known users to the first group 20a. In an embodiment, the request is effectively accompanied by the TempIDs for each user, as the users' DomainIDs are not made available to the match module 17 (as with the propagation server 16).

The match module 17 then obtains the TempIDs of the users known to the second group 20b. In one implementation, the propagation server 16 keeps a record of the TempIDs of each group 20, and therefore has already obtained the TempIDs of the second group 20b. In another implementation, the groups 20 regularly provide a listing of known TempIDs to the propagation server 16, which may have the benefit of allowing the groups 20 to control which users are made known to the match module 17. In yet another implementation, the TempIDs are communicated to the match module 17 on an as-needed basis—that is, in response to a request made by the match module 17.

In FIG. 11A, the TempIDs known to the second group 20b are represented by “TempID_2_A” to “TempID_2_H”. Similarly, the TempIDs known to the first group 20a are represented by “TempID_1_A” to “TempID_1_H”. The match request 75 is shown as being a request related to “TempID_1_A” of the first group 20a (which should be understood as an illustrative example.

The match module 17 then coverts the TempID received form the first group 20a into a first UserID. The match module 17 can maintain a record of UserIDs associated with TempIDs of the second group 20b or can convert as-needed. The match module 17 then identifies whether a TempID of the second group 20b corresponds to the TempID of the first group 20a, by identifying whether the first UserID is shared with a UserID of the second group 20b (whether a “match” exists or not). The match module 17b then issues a match response 76 to the first group 20a indicating that a match does or does not exist, as appropriate. The TempIDs of the second group 20b can also be accompanied by additional information, such as which specific domains have been visited by each TempID. In this case, the match module 17 can include in its response the additional information. In a variation, the original request is required to specify a particular one or more domains of the second group 20b, and only additional information related to these specified one or more domains is included in the request (where a match exists).

In an embodiment, the first group 20a can communicate one or more TempIDs to the match module 17 and all of these are compared to the obtained TempIDs of the second group 20b. One or both groups 20a, 20b can then be provided with match information for each of their TempIDs which were made available to the match module 17.

FIG. 11B illustrates an embodiment in which the various groups 20 (for illustrative purposes, a first group 20a and a second group 20b are shown) provide a listing of TempIDs to the match module 17 from time to time, for example, in response to a request issued by the match module 17 or periodically without a specific request. The match module 17 can then maintain a match database 77 indicating which TempIDs of the various groups 20 are associated with the same UserID. FIG. 11B shows an example of a subset of the TempIDs being recorded as matching within the match database 77, as it is not expected generally that every DomainID of the first group 20 will have a corresponding DomainID in the second group 20b (e.g. because the corresponding user has not visited a domain in each group 20a, 20b). Advantageously, the embodiment of FIG. 11B can provide relatively fast responses to received match request 75.

In a variation, in response to a group 20 providing a listing of TempIDs, the match module 17 undertakes the disclosed matching procedure and responds immediately to the requesting group 20 with a listing of its TempIDs which are matched in one or more other groups 20—the particular one or more other groups 20 can be specified with the request. Therefore, the requesting group 20 is enabled to maintain its own database of matches to other groups 20. In a preferable implementation, the one or more other groups 20 are also provided with the results (e.g. which of their TempIDs are present in the requesting group 20).

The particular user's web browsers are not involved with the process of FIGS. 11A and 11B. In an embodiment, the users are enabled to specify whether they agree to cross-group sharing of information (which can be specified on a per group basis, for example, the user may allow sharing between some groups but not others)—this is stored as user-set match rules. As the users' web browsers are not involved with the match procedure, the user-set match rules cannot be stored in the users' user-set propagation rules (although a copy of the user-set rules can, of course, be stored on the user-set propagation rules). Instead, the user-set match rules are stored with the match module 17 to thereby allow access with data communication with the users' web browsers. The propagation server 16 can be configured, therefore, to set and update the user-set match rules as a result of user input, for example, when the user is modifying their propagation rules. Therefore, when deciding whether to report a match, the match module 17 applies the user-set match rules (if available) to determine whether a match can be reported, even when it exists.

It may be desirable to provide means to inform a web browser on a client device 11 that a particular redirect between web resources of different domains is trusted (e.g. the domains of the web servers (and domain servers) and the propagation domain). Similarly, it may be desirable to provide trust in relation to web page specific data (in particular, ETags) that may be associated with a different domain. In each case, the technique involved avoids certain privacy and security issues of third-party cookies, but may still be considered undesirable from a trust perspective.

In an embodiment, a trust signal is defined for which a web browser can be configured to identify. The trust signal should be data that is accessible by the web browser and that can be considered likely, if not certainly, to be controlled and originating from the same entity as controls the particular domain. For example, it can be desirable for the entity that a domain server 12 on a first domain redirecting to, or accessing web page specific data (e.g. ETag) associated with, the propagation domain or another second domain, be enabled to do so, as the entity trust the other domain on account of knowingly implemented a service utilising an embodiment herein described. A suitable trust signal can inform the web browser to allow the interaction with the other domain, even in a case where the web browser would otherwise block such an interaction. For example, certain web browsers have recently stopped providing ETag access across domains.

In the particular embodiment considered, the DNS of the domain of the domain server 12 (i.e. of the entity) is modified—in particular, a record (assumed here to be a TXT record) is entered identifying each trusted domain (for example, as a plaintext list). E.g. in a case of a first domain, second domain, third domain, and propagation domain, the TXT records of the DNS entries for the first domain, second domain, and third domain are modified to refer to each other domain (including the propagation domain).

The DNS TXT record can reliably be assumed to be controlled by the same entity which controls the domain, and can therefore be considered trusted. Additionally, the web browser will likely cache the DNS information during a session in which aa user is accessing the domain on a client device 11. Therefore, the records are available to the web browser (likely in a cache) and can therefore be easily checked.

Therefore, when web browser is instructed to redirect (JavaScript, location header, etc.) or access information of another domain, it compares the other domain with the DNS TXT record to determine if that domain is present. When the web browser stores ETags (cache), for example, it can use the same logic to partition cache based on those domains, so that the same resource is cached across the entire collection and information and cache can be shared. It is also envisaged that this DNS TXT record approach, can be used as “second-party cookie” or “network-cookie” signal, to allow server side cookies to be set for those domains. That is, in effect, a third-party cookie effect (access from other domains) but without the inherent privacy and security issues. This means that if e.g. example.com calls a resource from example1.com, then example1.com can set cookie within a browser that belongs to example1.com despite user being on example.com (i.e. this would normally mean third-party cookie).

Certain advantages of this approach may include one or more of: (1) only a domain owner can control the trust, meaning no JS, browser or anyone else can manipulate this information; (2) even if someone reads TXT records, they mean nothing to them; and (3) if a company adds or removes a domain from their network, changes can be propagated effectively immediately, no updates to websites or any other components are needed.

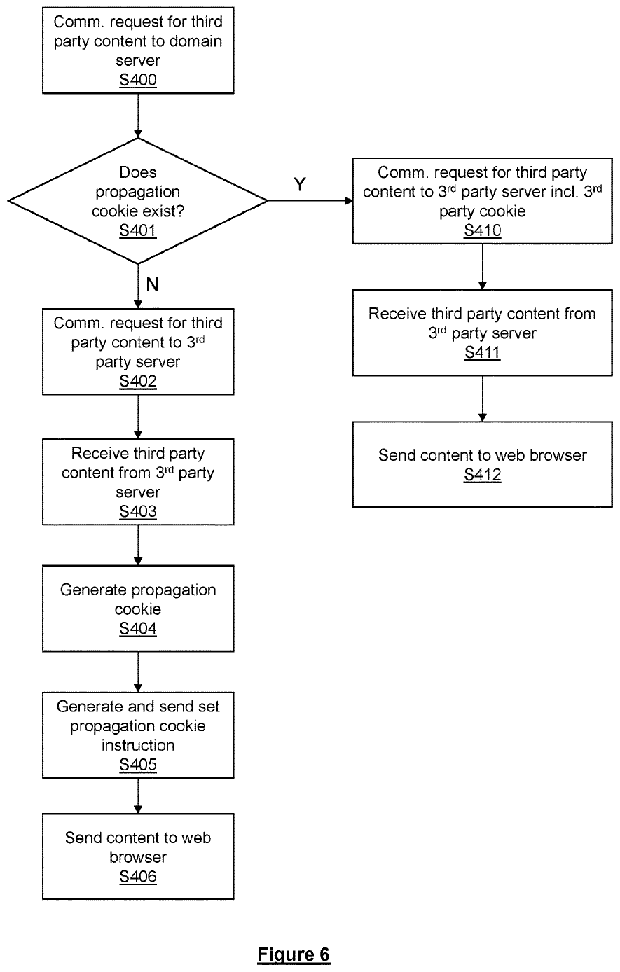

According to an embodiment, with reference to FIG. 6, there is provided a method for utilising a cookie associated with a third-party content server 14 (a “content cookie”) to determine the value for a domain cookie. Similarly, the method describes using a domain cookie present on the client device 11 for determining a content cookie to communicate to the third-party content server 14. This embodiment may advantageously enable a third-party content server 14 to continue to utilise third-party cookies while avoiding setting of such cookies on the client device 11.

In this case, the third-party content server 14 is associated with a different domain to both a web server 12 and its associated domain server 13, and therefore, is barred from directly setting a cookie value on the web browser in response to the web browser accessing the web page of the web server 12 (or at least it is desired for the third-party content server 14 to not set a third-party cookie).

Therefore, the domain server 13 effectively converts cookie values between those present on the client device 11 (domain cookies) and those utilised by the third-party content server 14 (content cookies). The method of FIG. 6 can apply in the case of step S112 of FIG. 3—that is, there is no domain cookie associated with a second web page present. In effect, the domain server 13 converts between the content cookies (being, effectively, third-party cookies) of the third-party content server 14 and first-party cookies set on the client device 11 (the domain cookies).

The content cookie can be associated with different functions. For example, the content cookie can enable tracking amongst different web pages or can provide for improved identify recognition.

According to this embodiment, the web browser communicates a request to the domain server 13 for information provided by the third-party content server 14. The present embodiment thereby utilises the domain server 13 as a proxy for the third-party content server 14. It should be understood that the embodiment described can be utilised using different proxy technologies. It should also be understood that the web content of the third-party content sever 14 can be accessed directly; importantly, however, cookie-related information is passed through the domain server 13 between the client device 11 and the third-party content server 14.

In a particular non-limiting example, the third-party content server 14 can be configured to provide advertising content to the web browser to accompany the content provided by the web server 12. As according to known technologies, the advertising content is provided dynamically and, where available, at least in part based on identifying information associated with the web browser (or, more particularly, the user of the client device 11). In the prior art, this identifying information can be stored within a third-party cookie stored on the web browser—thus, no matter the particular domain being visited while web browsing, targeted advertising can be provided.

At step S400, the web browser communicates to the domain server 13 a request for content from the third-party content server 14 (typically, the request will identify the third-party content server 14 although in some cases the domain server 13 can automatically identify the third-party content server 14). It should be understood that the request can be one that is only expected to return an instruction to set a content cookie associated with the third-party content server 14, although it is generally expected that a response with content for display on the web browser is provided.

The domain server 13 then checks, at step S401, for the presence of a previous set domain cookie, set by the domain server 13 on behalf of the third-party content server 14. Step S401 can comprise implementing the method of FIG. 3 (e.g. including execution of the first code on the web browser)—therefore, if a domain cookie has been set in association with another web page on a different domain, it is propagated to a domain cookie in relation to the present web page's domain and is therefore made available to the domain server 13 in relation to the current web page and is therefore determined as present. Of course, if the domain cookie is already present in relation to the current web page, it will also be determined as present.

If a domain cookie is not set (previously or via propagation), the domain server 13 then communicates a request to the third-party content server 14 for the relevant third-party content, at step S402. The request is not accompanied by a content cookie for use by the third-party content server 14—that is, the domain server 13 does not generate a content cookie based on an existing domain cookie. At step S403, the third-party content server 14 returns (either to the domain server 13 or directly to the web browser of the client device 11) the content. Additionally, the response of the third-party content server 14 includes an instruction to set a content cookie comprising some data. In the advertising content example, the third-party content server 14 can generate a new identifier to accompany content cookie for identifying the client device 11.

At step S404, the domain server 13 generates a domain cookie based on the value of the content cookie set by the third-party content server 14. For example, the domain cookie can be generated according to an encryption algorithm or hashing algorithm applied to the data of the content cookie. The domain cookie can be considered a converted “third-party” cookie, in that the content cookie is associated with a different domain to the domain cookie (and, in addition, the domain of the web server 12). At step S405, the domain server 13 generates and sends an instruction for the web browser of the client device 11 to set the domain cookie (e.g. with an attribute such that the processing server cookie is available to executable code, e.g. by not setting HttpOnly). At step S406 (which typically occurs simultaneously with step S405), the content is communicated from the domain server 13 to the client device 11.

As a result of step S405, a domain cookie has been set on the client device 11 recording information derived from that set by the third-party content server 14 in the content cookie. However, the domain cookie, as discussed, is a first-party cookie. The domain cookie can be propagated in the future as according to, for example, the method of FIG. 3 and is therefore available when the client device 11 visits other related web pages, associated with different domains.

Referring back to step S401, if a domain cookie is set, the domain server 13 then communicates a request to the third-party content server 14 for the relevant content provided by the third-party content server 14, at step S410. The request is accompanied by the content of, or derived from, the domain cookie, for use by the third-party content server 14—that is, the domain server 13 communicates a cookie (or said information) based on the domain cookie. At step S411, the third-party content server 14 returns (either to the processing server 13 or directly to the web browser of the client device 11) the content. The third-party content server 14 is not required to generate a new content cookie. Typically, the content is generated at least in part based on the cookie information (derived from the domain cookie) communicated to the third-party content server 14 (e.g. targeted advertising). This content is then communicated to the web browser of the client device 11, for example, via the domain server 13 acting as a proxy, at step S412.

Advantageously, the methods of FIG. 3 and FIG. 6 can operate together to enable an effect similar to that provided by third-party cookies while only setting first-party cookies on the client device 11. That is, a plurality of first-party domain cookies can record the same information derived from the content cookie, each associated with a particular domain. Each domain cookie can then be utilised to generate cookie information for communicating to the third-party content server 14. From the perspective of the third-party content server 14, the same value is received despite the particular web resource being accessed by the web browser of the client device 11, and therefore, the web browser (or the particular user combined with the particular web browser) can be identified—the third-party content server 14 does not require modification in order to provide content and cookies to the client device 11 as the conversion between third-party cookies and first-party cookies is handled by the domain server 13.

In a variation, in relation to the method of FIG. 5B, the propagation server 16 can take the role of the domain server 13 by transcribing between the content cookie from the third-party content server 14 and the domain cookies for each web page domain.

In an embodiment, it is desirable to set an auxiliary cookie for at least one domain cookie. Each auxiliary cookie can record the same information as its associated the domain cookie, or at least, information derivable from the domain cookie (or from which the domain cookie is derived). In effect, each auxiliary cookie set will comprise representations of the same information, although, typically, the domain cookie is a modified version of the auxiliary cookie, or vice versa. Each auxiliary cookie is set with an attribute barring access by executable code executed on the web browser—that is, for example, the HttpOnly attribute can be set. Such an embodiment can provide an advantage as the domain cookies set due to interactions with the third-party content server 14 can be set without the HttpOnly attribute—thus, the domain cookie is readable by executable code such as JavaScript but the auxiliary cookies are not.

According to an embodiment, each time a domain cookie is set, an auxiliary cookie is also set. However, instead of reading the value of a domain cookie for generating a communication of information to the third-party content server 14, the associated auxiliary cookie is accessed.

In an embodiment, the auxiliary cookie is equal in value to a content cookie, and the domain cookie is an anonymised equivalent of the content cookie. This embodiment can be useful where it is preferred to set a cookie which is not accessible to executable code (e.g. with HttpOnly set) which can comprise non-encrypted information (e.g. in plaintext)—this is, the auxiliary cookie performs a similar function to third-party cookies when set in the prior art. However, the domain cookie is anonymised using an encryption function—therefore, there is lower risk in setting it as accessible to executable code (e.g. without HttpOnly set) as the data contained is not easily readable. The auxiliary cookie can have the effect of being a conversion of the content cookie into a first-party cookie—it appears to have exactly the same content, it is simply set by the domain of the web page rather than a different domain.

Embodiments described herein can be utilised for a variety of implementations. An example previously discussed is for advertising tracking. Another example is user identification for website access purposes. In the prior art, a third-party cookie can be utilised to identify a particular web browser as known for different websites hosted on different domains—in this way, a particular user can avoid identifying themselves each time they visit one of these websites. The embodiments described herein can be utilised to provide the same effect as the third-party cookie while only setting first-party cookies on the client device.

Generally, many situations in which third-party cookies are used in the prior art to provide for websites on different domains to access the same cookie data, certain embodiments may be suitable for providing a similar effect while only setting first-party cookies on the client device 11.

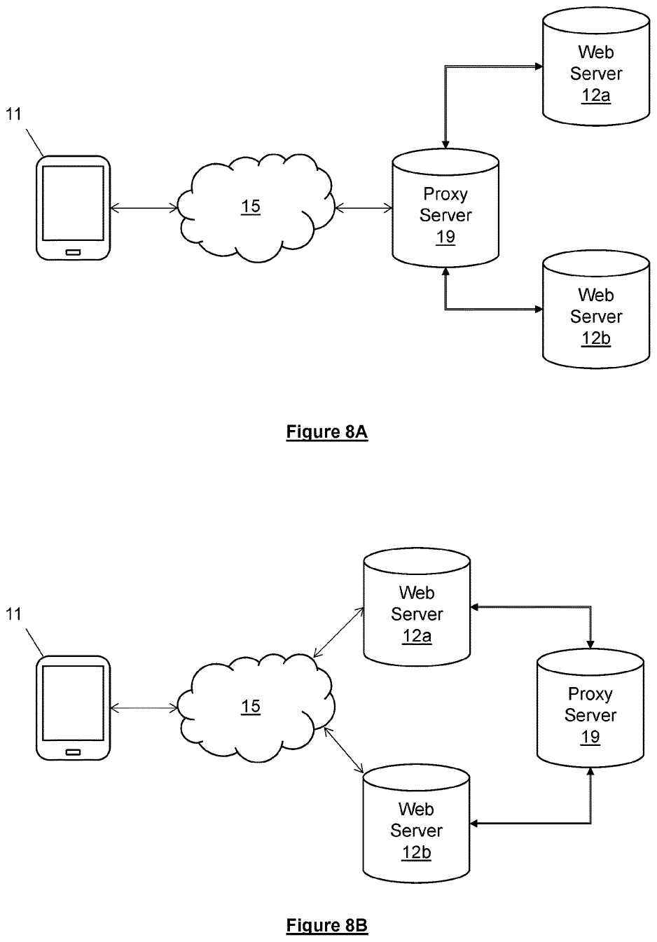

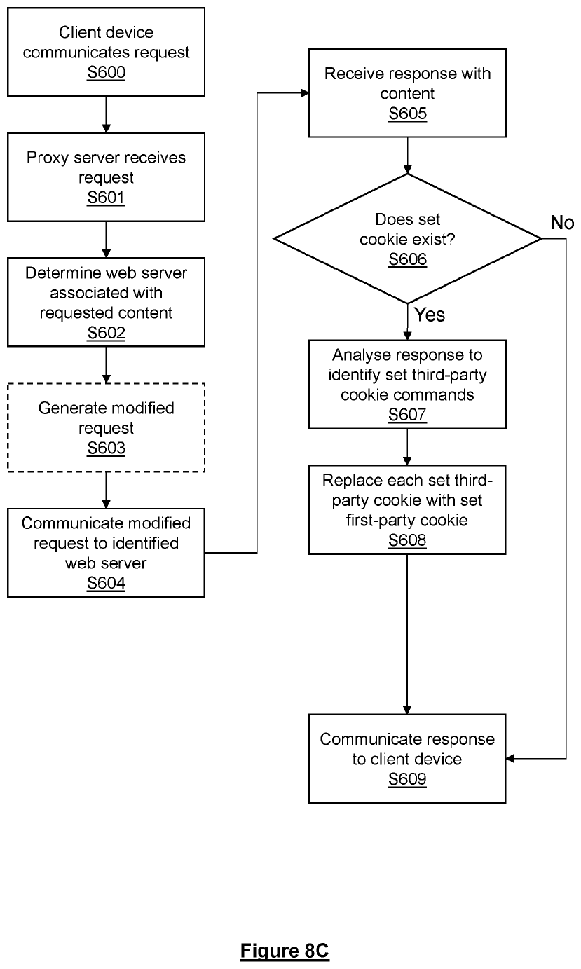

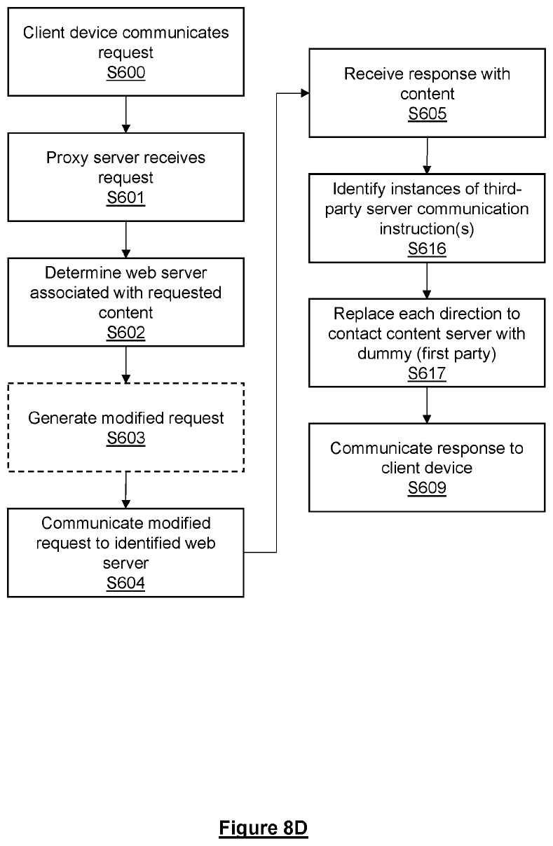

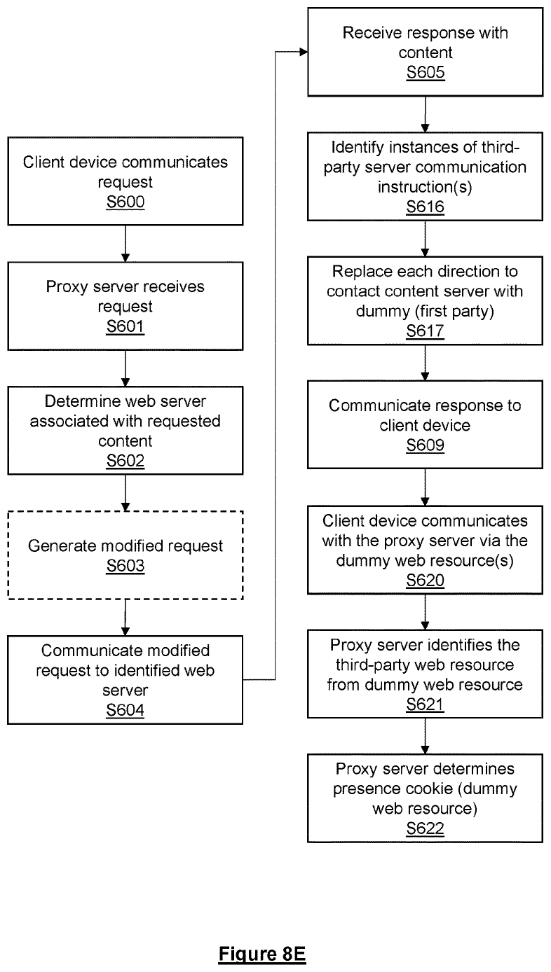

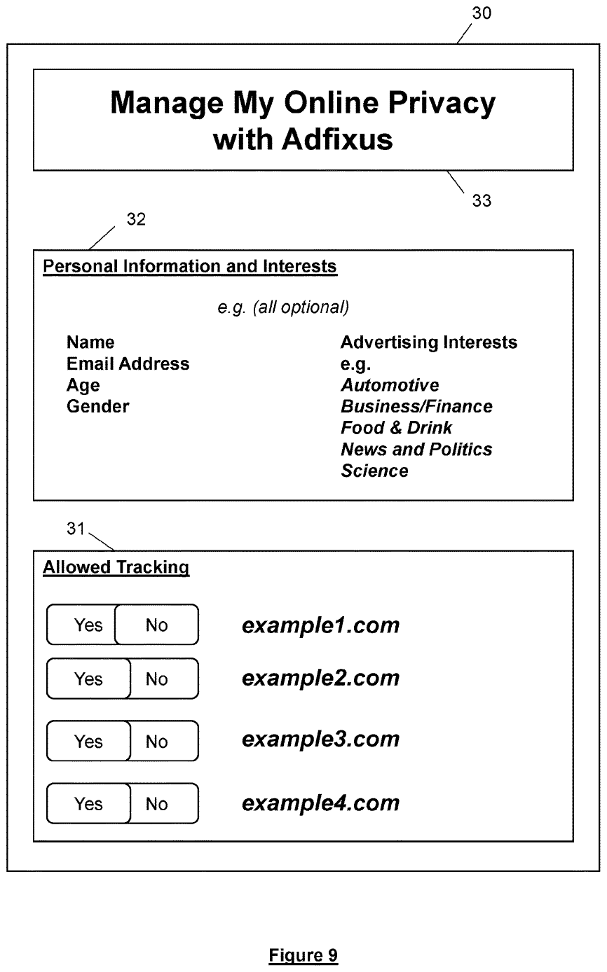

FIGS. 8A and 8B show topologies for implementing an embodiment shown in FIG. 8C and FIG. 8D, in which proxy server 19 is configured to intercept requests directed towards different web servers 12a, 12b from the client device 11. The web servers 12a, 12b are associated with different domains (e.g. first domain for first web server 12a and second domain for second webs server 12b) such that first-party cookies for one domain are not readable by the web server 12 of the other domain, etc. Proxy server 19 can be a logical function of the proxy server 19 or a domain server 13 or can be implemented as a different physical or logical server.

This can be effected in different ways, for example, with reference to FIG. 8A, the proxy server 19 may be associated with the domains of the web servers 12 via suitably configured DNS records, and the proxy server 19 is configured to communicate directly with the web servers 12 (for example, via network 15 or implemented as different logical functions within the same physical hardware or in direct data communication separate to the network 15). The proxy server 19 is configured to identify the appropriate web server 12 for a particular received request based on content of, or associated with, the request.

In another example, as shown in FIG. 8B, the requests are received by the relevant web servers 12, which are then configured to forward the request to the proxy server 19 (for example, via network 15 or implemented as different logical functions within the same physical hardware or in direct data communication separate to the network 15), said requests being modified and returned to the relevant web server 12. Similarly, responses by the web servers 12 are first forwarded to the proxy server 19, which can modify the responses and return to the web server 12, which then communicates the modified responses to the client device 11.

In either example, the proxy server 19 is configured to modify, in certain cases, communications from the client device 11 intended for the relevant web server 12 and, in certain cases, communications from the web servers 12 intended for the client device 11.

Relevantly, the web servers 12 are configured to communicate set cookie commands for setting third-party cookies. The embodiments of FIGS. 8A-8C are configured to modify said commands such as to cause setting of first-party cookies while retaining the information intended for the third-party cookies.

At step S600, the client device 11 communicates a request for content (e.g. via a web page request), which is received by the proxy server 19, at step S601. The request is associated with the first domain (e.g. www.example.com). The request typically will specify a particular web page for which content is desired—it should be noted that a default web page can be selected (e.g. http://www.example.com/index.html). Relevantly, the content which is requested is, at least in part, stored and/or generated by the first web server 12a. At step S602, the proxy server 19 identifies the intended web server 12 for the request (for this example, assumed to be the first web server 12a).

Optionally, at step S603, the proxy server 19 generates a modified request based on the received request. The modified request comprises the information of the received request or information derived from said request such as to enable the web server 12 to provide the requested content. Said information can include some or all information of a header of said request. In an embodiment, step S603 comprises copying header and body information of the request when generating the modified request. The modified request may include information such that, when a response is received from the web server 12, it is enabled to identify the original client device 11.

At step S604, the proxy server 19 then communicates the modified request to the first web server 12; that is, the web server 12a identified at step S602. Relevantly, the modified request identifies the proxy server 19 for receiving a response to the modified request, the response generated by, and received from, the first web server 12a. That is, from the perspective of the first web server 12a, the modified request originates from the proxy server 19.

At step S605, the proxy server 19 receives a response generated by the first web server 12a. The response, for the purposes of exemplifying the method, comprises one or more “set cookie” commands, which are instructions to the web browser of the user device 11 to set a cookie.

The proxy server 19 is configured to analyse the received response in order to determine, at step S606, if one or more set cookie commands are present associated with a domain different to the first domain—any such domains are termed “third-party domains”. If one or more said commands are present, the method proceeds to step S607. Otherwise, the method proceeds to step S608.

In the event that one or more set cookie commands are present, the proxy server 19 is configured to replace reference to the, or each, third-party domain with a new reference to the first domain, at step S607. The proxy server 19 is typically configured to parse the response in order to identify and replace references to third-party domains with the domain of the first web server 12a, thereby creating a first-party cookie. The content of the first-party cookie can be the same as the third-party cookie.

The response, as processed, is then communicated to the web browser of the client device, at step S608.

FIG. 8D relates to an embodiment which may be optionally implemented with that of FIG. 8C. Steps S600-S604 are equivalent to those of FIG. 8C.

As with FIG. 8C, at step S605, the proxy server 19 receives a response generated by the first web server 12a. The response, for the purposes of exemplifying the present method, comprises executable code (e.g. JavaScript) comprising instructions for the web browser of the client device 11 to undertake one or more instances of communication with one or more third-party content servers 14 (one is assumed here)—herein, content server communication instruction(s). The response also typically comprises content intended for rendering by the receiving web browser and/or executable code for execution by the web browser (e.g. JavaScript).

The proxy server 19 is configured to analyse the received response in order to identify, at step S616, the one or more instances of third-party server communication instruction(s) (e.g. by parsing the response)—that is, instructions to contact another web server 12 such as second web server 12b.

At step S617, the proxy server 19 is configured to replace reference to the particular web resource of the, or each, third-party server communication instruction with a reference to a dummy web resource, in which the domain of the first web server 12a is utilised such that the proxy server 19 receives communications directed towards the dummy web resources. The response, as processed, is then communicated to the web browser of the client device, at step S609.

In an embodiment, the proxy server 19 maintains, in a memory, a mapping database in which a mapping record is maintained between generated dummy web resources and the original web resource (i.e. the target of the associated content server communication instruction).

FIG. 8E (which includes steps of FIG. 8D) describes a process whereby the client device 11, upon receiving the executable code of FIG. 8D, communicates with the proxy server 19 via the dummy web resource(s), at step S620. The proxy server 19 compares the dummy web resource(s) to its mapping database to identify the actual third-party web resource (e.g. at the second web server 12b), at step S621. At step S622, the proxy server 19 determines if there are any cookie on the client device 11 associated with the dummy web resource (and therefore recorded as a first-party cookie of the first domain). Any such cookies are communicated to the third-party web resource (e.g. second web server 12b) along with a request for content as according to the mapped resource. Assuming a response is received, the content thereof is passed to the client device 11 and, if necessary, the steps of FIGS. 8C and 8D are repeated on this returned content.

In this way, the proxy server 19 can advantageously hide the third-party web resource from the client device 11, while still enabling content to be delivered from the third-party web resource to the client device 11.

The disclosure herein has focused, for the most part, of storing information in first-party cookies. An advantage of cookies over other mechanisms for storing information in a web browser is that cookie data is provided to a server (e.g. web server 12, domain server 13, and propagation server 16) as part of a normal HTTP GET request—that is, cookies provide their data to the server without requiring a specific request for the data to be made by the server. However, in principle, at least some of the first-party information herein can be stored in other data structures, such as web browser local storage or a database such as IndexedDB, where these data structures are also, effectively, “first-party” in that the content is not accessible by servers on other domains. Therefore, the techniques described herein in relation to first-party cookies should be understandable as applicable, if appropriate, more generally to “first-party” data structures. In one possible example, some or all user-set propagation rules are stored in an IndexedDB while the UserUD is stored in a propagation cookie, thereby making the UserID immediately available to a propagation server 16 while allowing a subsequent request to be made for the propagation rules, if deemed necessary by the propagation server 16. In another possible example, IndexedDB or other web browser data structure is used in place of the propagation cookies, domain cookies, and/or another other first-party cookie described herein.

FIG. 12 shows a media content delivery system (herein “content system”) 40, according to an embodiment. The content system 40 comprises a primary content server 41, a secondary content server 42, and a client device 11, each in data communication with the network 15. It is assumed that the client device 11 of content system 40 is the same as that previously described with respect to communication system 10, however, the content devices 11 may be different, depending on the particular implementation. As previously described with respect to communication system 10, typically, the network 15 comprises the Internet, although it may comprise an intranet in addition or alternatively to the Internet. More generally, the primary content server 41 and secondary content server 42 can be in data communication with one another via a path which does not comprise network 15. For example, the primary content server 41 and secondary content server 42 can be implemented as separate functions of a common physical or virtual server such that data communication is via access to a shared memory space. In an example, either or both of the primary content server 41 and secondary content server 42 are implemented in a cloud-based or distributed computing environment. In another example, either or both of the primary content server 41 and secondary content server 42 are implemented is dedicated computing architecture (which can include a network of computers implementing the functionality of a single server).

Generally, the servers 41-42 can be implemented in appropriate hardware as desired. For example, each server 41-42 can be implemented in dedicated computing hardware. However, cloud-based implementations are also envisaged, such as provided by Amazon Web Services (AWS), Microsoft Azure, Google Cloud Platform, and Oracle Cloud, in which one or more servers 41-42 are implemented as virtual servers. Generally, each server 41-42 is associated with a processor and memory, wherein the processor executes code to implement the functionality of said server 41-42 and the memory is provided to store said code as well as to provide a working memory space. The memory can comprise both volatile and non-volatile memories. Each server 41-42 is provided with access to said network 15 and/or directly to one or more of the other servers 41-42, depending on the requirements of the particular implementation.

The content system 40 of FIG. 12 should be understood as an exemplary representation of data connections between various elements, however, should not be considered limiting.

The primary content server 41 hosts (or otherwise manages access to) primary content 44. In a general sense, the primary content server 41 is configured to receive primary content requests via the network 15 from client devices 11, undertake a primary server analysis procedure for each primary content request, and generate primary content responses in dependence on the outcome of the primary server analysis procedure (i.e., therefore, a primary response is generated in response to receiving a primary content request). A primary content response typically comprises a selection of one or more instances of primary content 44 determined by the primary server analysis procedure. That is, the primary content response typically includes some, but not all, of the hosted primary content 44. The primary content response is communicated to the requesting client device 11 via the network 15. The primary server analysis procedure is typically dependent upon, at least in part, request parameters included as a component of the corresponding primary content request. The selection of the primary content 44 can also depend on other factors, such as a primary user profile associated with a user of a particular client device 11. The primary server analysis procedure could, in an implementation, simply correspond to the primary content server 41 returning all primary content 44 as part of the primary content response.

In an example implementation, the primary content server 41 provides primary content 44 in the form of “search results” to requesting client devices 11 (i.e., in response to receiving primary content requests including, as a request parameter, a “search request”). The primary server analysis procedure therefore corresponds to identifying search results based on the received search request. In a particular example of this implementation, the primary content server 41 can correspond to a marketplace platform for the buying and/or selling of products and/or services, and the search results are products and/or services of interest to a user of a client device 11 as defined by the request parameters (e.g., which can comprise search terms) of a corresponding search request.

In order to assist with exemplifying embodiment, the term “search result” may be used in place of reference to a selection of the primary content 44. Similarly, the term “search request” may be used in place of reference to a primary content request. It is not intended that the usage of these terms implies a limitation of applicability of the described embodiments to search results, unless expressly stated. The requesting and providing of search results represents an easily understood implementation of one or more embodiments described herein.

Secondary content server 42 hosts secondary content 45. In a general sense, the secondary content server 42 is configured to receive secondary content requests via the network 15, undertake a secondary server analysis procedure for each secondary content request, and generate secondary content responses in dependence on the outcome of the secondary server analysis procedure (i.e., therefore, a secondary content response is generated in respect to receiving a secondary content request). A particular secondary content response typically comprises one instance of (or, in an alternative, a selection of one or more instances of) the secondary content 45, which is communicated to the client device 11 via the network 15. The selection of secondary content 45 can depend on several factors, such as a secondary user profile associated with a user of a particular client device 11. The selection of secondary content 45 can in part depend on an associated primary content request and/or an identity of the associated primary content server 41. Relevantly, the selected secondary content 45 is not determined directly by the primary content server 41.

In an example implementation, the secondary content server 42 provides secondary content 45 in the form of online advertising (usually understood as corresponding to discrete “adverts” or “ads”) to respective client devices 11 in response to receiving secondary content requests in the form of “ad requests”. The secondary content server 42 is therefore commonly known as an “ad server”. A particular ad request typically defines one or more allowable ad formats. The particular selection of one or more ads is typically limited to only those corresponding to the one or more allowable ad formats. For the purposes of the present disclosure, an ad format corresponds to a display property of the ad, such as a display size of the ad. The secondary content server 42 is then configured to identify a particular ad (or, in some embodiments, the secondary content server 42 can be configured to identify one or more particular ads) meeting one of the allowable ad formats to return to the client device 11.

In order to assist with exemplifying embodiment, the terms “advert” and “ad” may be used in place of reference to a selection of the secondary content 45. Similarly, the terms “advert request” and “ad request” may be used in place of reference to a secondary content request. It is not intended that the usage of these terms implies a limitation of applicability of the described embodiments to providing adverts, unless expressly stated. The requesting and providing of ads represent an easily understood implementation of one or more embodiments described herein.

In an embodiment, the secondary content requests are generated by respective client devices 11 and communicated directly (via network 15) to the secondary content server 42 at the same time as the primary content request is communicated (via network 15) to the primary content server 41. Here, the “same time” should be understood to include “closely in time”, for example, the secondary content request could in practice be communicated in response to receiving the primary content response. This may be applicable, for example, where the primary content response defines a requirement of the secondary content request (for example, a number of instances of secondary content 45 required). In another embodiment, the secondary content requests are generated by the primary content server 41 and communicated to the secondary content server 42 in response to receiving a primary content request. In either case, the secondary content server 42 can be configured to communicate the secondary content response directly to the respective client device 11 via network 15 or, alternatively, the secondary content server 42 can be configured to communicate the secondary content response to the primary content server 41 which itself communicates the secondary content response to the respective client device 11. Therefore, in a general sense, a secondary content response is communicated to the client device 11 as a result of the client device 11 generating a primary content request.

The client device 11 is configured to run a primary content application which acts to control the client device 11 to undertake the data communications herein described. The primary content application in general terms can correspond to a “native application” associated with a primary content entity. The primary content entity is also associated with the primary content server 41. The primary content entity should therefore be understood as representative of the nature of the primary content. For example, the native application can be associated with a trade mark indicating that the primary content entity is the source of the native application.

The native application (or equivalently “native app”) may be known colloquially as an “app”. The app is installed to (and, when in use, running on) a smartphone or other client device 11. The app presents, via a display of the client device 11, an icon and, when running, a get up (e.g., including a trade mark) identifying the primary content provider. The native application typically includes primary content display rules (typically predefined) for displaying received primary content 44. Therefore, the native application is configured to present, on a display of the client device, received primary content 44 according to the primary content display rules. In the case of search results, a common form of display is a list of N search results (or smaller than N if the number of search results is fewer than N). Here, N is a predefined number of results that can be user selected or set by the programming of the native application. Relevantly, the primary content 44 itself is not required to define how it is to be displayed and therefore can comprise only the search result data (which can include multimedia including images, video, and/or sound).

In contrast, the primary content application can instead correspond to a web application (“web app”) implemented by directed a web browser of the client device 11 to a suitable web resource (often associated with a recognisable domain name, such as one easily identifiable with the primary content entity); that a web browser accessing a web application is not a native application. A common, but by no means limiting, model of a web application is as a multi-tiered application defined by code obtained by and executed by the web browser (e.g., usually comprising a mixture of hypertext markup language (HTML), cascading style sheets (CSS), and JavaScript, or more rarely equivalents of one or more therefore), code executed by a web server associated with the web application for dynamically generating content (e.g., utilising one or more of ASP, CGI, ColdFusion, Dart, JSP/Java, Node.js, PHP, Python, and Ruby on Rails), and a database accessed by the web server. The web browser therefore provides a generic means for implementing the primary content application. When doing so, the display of the web browser typically includes get up (e.g., including a trade mark) identifying the primary content provider.

Embodiments described herein primarily relate to instances in which the primary content application is implemented as a native application. Generally, the term “native application” is used in place of “primary content application” to further clarify this. However, in order to assist with exemplifying the embodiments, reference is made at times to similarities and differences between the primary content application being implemented as a native application and as a web application.

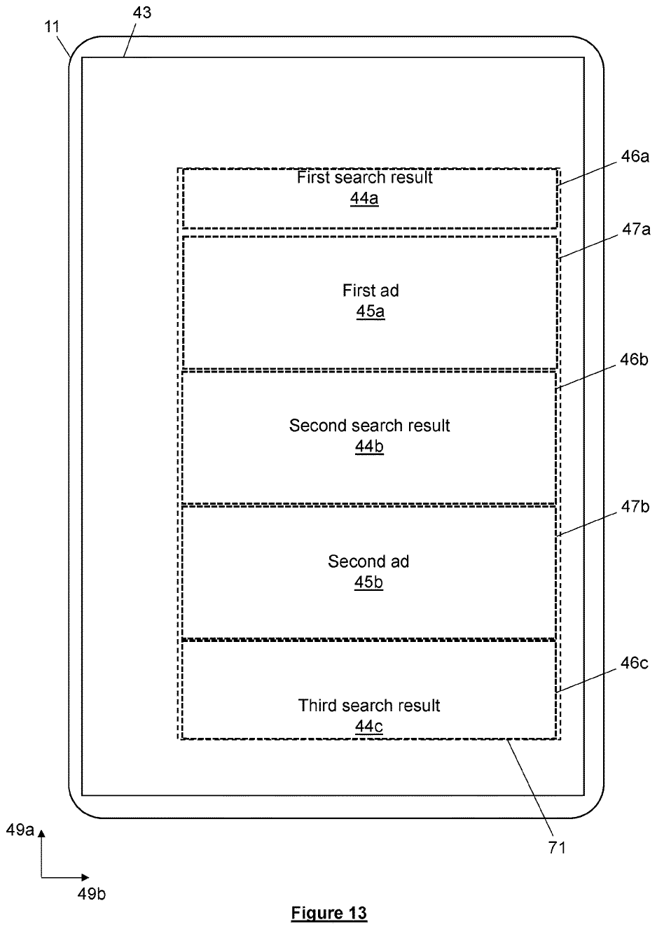

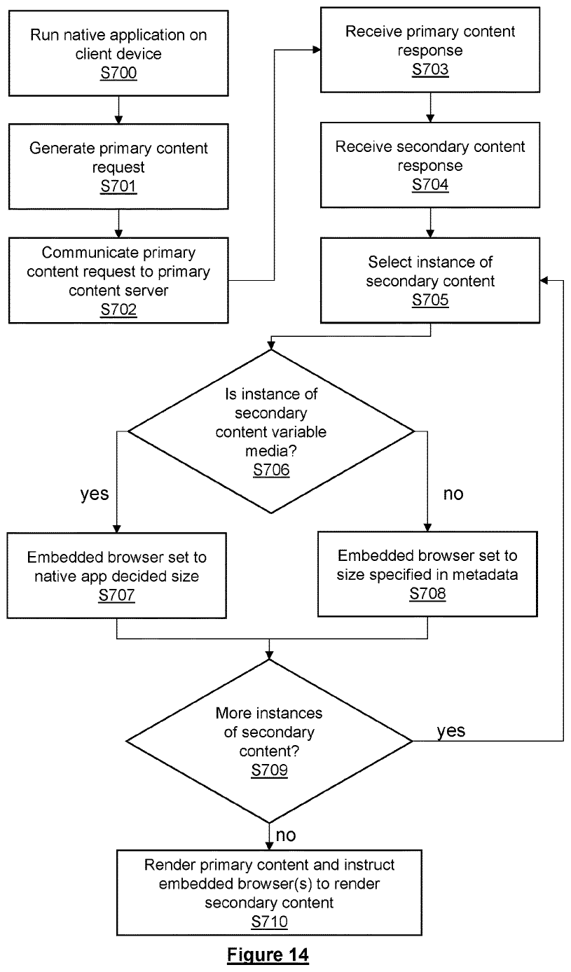

FIG. 13 illustrates a situation in which secondary content 45 is intended for display on a display 43 of the client device 11 simultaneously with the primary content 44. In the example shown, a first instance of secondary content 45a (e.g., a first ad) is to be presented between a first instance of primary content 44a (e.g., a first search result) and a second instance of primary content 44b (e.g., a second search result), and a second instance of secondary content 45b (e.g., a second ad) is to be presented between the second instance of primary content 44b and a third instance of primary content 44c (e.g., a third search result). As used herein, received primary content 44 and secondary content 45 is considered to be displayed “simultaneously” when presented as a unified whole as understood by a user of the client device 11. In practice, often only a portion of said unified whole is physically displayed on the display 43 at any point in time. However, the user is provided with an indication (e.g., a visual indication on the display 43) that there is further content available. For example, a common technique is to allow a user to “scroll” the content up and down, thereby causing successive portions of the search results to be displayed (e.g., where the display 43 comprises a touch screen, scrolling is effected by the user touching and sliding a finger up or down, or via a human interface device such as a keyboard or mouse). In the example of FIG. 13, the first and third instances of primary content 44a, 44c are located partially “off-screen”.

The display 43 is associated with a physical display area (i.e., the physical size of the screen). During use, the native application utilises a content display area 48 (shown with dotted lines), which is typically a portion of the physical display area. Usually, the native application also utilises portions of the physical display area outside of the content display area 48 (shown shaded in the figure). However, the presentation of primary content 44 and secondary content 45 is restricted to the content display area 48. Although not shown, the remainder of the physical display area (if any) can be utilised by separate software to the native application (for example, portions of the underlying operating system user interface). The content display area 48 can be associated with a resolution defined by a number of pixels in a first direction 49a and a number of pixels in a second direction 49b. The first direction 49a and second direction 49b can each be associated with a length, representing the actual size of the content display area 48. Unless indicated otherwise, the term “display size” as used herein refers to the resolution of a particular element (i.e., a number of pixels in the first direction 49a and a number of pixels in the second direction 49b).

The term “results presentation” is used to refer to the understood total presentation of received primary content 44 and secondary content 45 (which often can include additional elements which are not relevant here). The term “displayed portion” is used to refer to the currently presented position of the results presentation.

In practice, the secondary content 45 hosted by the secondary content server 42 includes secondary content 45 associated with a plurality of different media formats. For example, in the case of ads, the media format can be a static image, an animated image, or a video, having a defined resolution. Media formats with defined resolutions are referred to as “non-variable media formats” herein, which is understood to relate to a display resolution or size of the media format. The media format can instead comprise coding configured to adjust the presentation of the particular media in dependence on display resolution or size. In terms of ads, this is a property that can apply to so-called “rich media” (Reference [1]). Media formats in which the display changes for between a first resolution and a second resolution in a manner that is not merely rescaling of the media are referred to herein as “variable media formats”. Typically, at least in terms of adverts, variable media formats comprise HTML code, and usually either or both of CSS and JavaScript, defining at least two different display arrangements of the ad depending on the available resolution (e.g., horizontal and/or vertical number of pixels) in which the advert is to be displayed.

Still referring to FIG. 13, in an embodiment, the native application is configured to present, as a results presentation, a listing of search results. The listing comprises an arrangement of separate instances of primary content 44a-20c arranged in sequence (from top to bottom in the particular example shown). Each instance of primary content 44a-20c is allocated a corresponding primary content window 46a-63c, which defines the display size of the instance of primary content 44a-20c. In the example shown, each primary content window 46a-63c has the same display size. In an embodiment, because the native application is configured for generating the particular appearance of the instances of primary content 44a-20c, it is enabled to determine an appearance for each instance of primary content 44a-20c in dependence on the display size of each corresponding primary content window 46a-63c. In turn, the display size of each primary content window 46a-63c can be dependent on the content display area 48 which itself can be dependent on the physical display area.

In general terms, according to the present embodiment, the native application is configured to arrange one or more secondary content windows 47 (as shown, there are two secondary content windows 47a and 47b) within the same results presentation as the primary content 46. Each secondary content window 47a, 47b is associated with a particular instance of secondary content 45a, 45b. The native application is configured to utilise an external module (e.g., provided by the operating system of the client device 11) for presenting the secondary content 45a, 45b within each secondary content window 47a, 47b. For example, the external module can be the “Web View” module provided by the Android operating system (Reference [2]), which allows native applications to “embed” a web browser (corresponding to Web View) specifically instructed to render the secondary content. In general terms, the native application calls the external module and instructs the external module to display a corresponding instance of secondary content 45 within the corresponding secondary content window 47a, 47b. Notably, the native application itself does not render the instances of secondary content, this is undertaken by the external module. In the case of Web View, the native application is not required to include its own web browser functionality as instead a web page is embedded and utilised for secondary content.

Note that the primary content 44 and secondary content 45 are indicated as a shaded components withing their corresponding primary content window 46 or secondary content window 47. The primary content windows 46 and secondary content windows 47 are shown with exaggerated bold dotted outlines; in practice, it is unlikely that the user will be provided with a visually perceptible representation of the primary content windows 46 and secondary content windows 47 (although the associated primary and secondary contents 44, 45 may display a border or similar commensurate with the associated primary content window 46 or secondary content window 47).

Existing native applications are known which are configured to utilise secondary content windows 47a, 47b which are fixed in display size before the instance(s) of secondary content 45a, 45b are obtained from the secondary content server 42. This enables the native application to generate a preliminary results page in which the primary content windows 46a-63c and the secondary content windows 47a, 47b are pre-arranged relative to one another. In the example shown, the primary content 44a-20c itself can already be available to the native application and therefore the preliminary results page comprises the actual presentation of the instances of primary content 44a-20c within the corresponding primary content windows 46a-63c (the primary content 44a-20c is represented using shading; that is, the primary content 44a-20c is located within the corresponding primary content windows 46a-63c), while the secondary content windows 47a, 47b are at this stage empty (represented by a lack of shading). Alternatively, the preliminary results page can be generated before the instances of primary content 44a-20c have been communicated to the native application. In either case, the display sizes of the primary content windows 46-63c can be known at the time of generating the preliminary results page.

A reason this approach is utilised is that it allows for the preliminary results page to be presented on the client device 11 before the secondary content 45a, 45b is obtained. By fixing the display size of the secondary content windows 47a, 47b (and, typically, the primary content windows 46a-63c), there will be no relative changes (i.e., the relative positions of the primary content 44 to one another and with respect to the secondary content windows 47a, 47b) to the results presentation once the secondary content 45a, 45b is obtained.

Typically, for commercial reasons, the secondary content request communicated to the secondary content server 42 specifies a plurality of allowable media formats for a particular instance of secondary content 45 (i.e., for use with a particular secondary content window 47). For example, the secondary content request can define several media formats having resolutions smaller than or equal to that of the secondary content window 47. Commonly utilised advert sizes are discussed at Reference [3]. Online advertising of often utilises competitive bidding techniques to select a particular advert to return in response to a secondary content request. Therefore, by specifying a plurality of allowable media formats, the competition for the particular advert slot is increased leading to higher advertising returns (typically, to the primary content entity).

A problem exists, however, in that the selected instance of secondary content 45 can be associated with a smaller display size than that of the secondary content window 47. In the prior art, two outcomes can result. In a first outcome, the selected instance of secondary content 45 is scaled such that its effective display size is equal to the display size of the secondary content window 47. In another outcome, the selected instance of secondary content 45 is displayed at its specified display size, irrespective of the display size of the secondary content window 47. Usually, the secondary content 45 in these cases has a smaller display size when compared to the secondary content window 47, in which case the native application is typically configured to leave “blank” space (or some other filler appearance not related to the secondary content) in the parts of the secondary content window 47 in which the secondary content is not present. In either case, the presentation of the secondary content 45 can be considered inadequate, because either scaling introduces distortions to the appearance of the secondary content 45 or the secondary content window 47 includes non-secondary content portions (i.e., “wasted space”).

As mentioned, variable media formats inherently allow for presentation at different display sizes. Therefore, an option is to limit the specified allowable media to variable media formats. However, in practice, a significant proportion of online advertisements are non-variable media formats, and therefore limiting to only variable media formats retains the commercial disadvantage of reducing potential advertising revenue. In addition, in practice, ad servers 42 themselves may not distinguish between variable and non-variable media formats (i.e., the secondary content request cannot specify that only variable media formats are allowed for selection).

Another related problem is a situation in which the secondary content responses do not include explicit information distinguishing non-variable media formats from variable media formats (e.g., it is not an available field associated with the secondary responses). That is, the native application cannot directly determine from the secondary content response whether it has received a non-variable media format or a variable media format.

Furthermore, a situation exists in which the external module utilised for rendering the particular instances of secondary content 45 provides an effective barrier between the secondary content and the native application. That is, although the secondary content itself could incorporate information identifying it as being a variable media format, this information is not readable by the native application. Equivalently, the external module cannot instruct the native application on whether the secondary content is a variable media format or non-variable format.

The embodiments herein described have been developed in particular view of these situations.

Existing functionality of native applications can be modified to allow the determination of whether received secondary content is of a variable media format or a non-variable media format. The approach avoids functional changes to the secondary content server 42; that is, the secondary content server 42 does not requiring modification to include with secondary content responses information identifying whether the instance of secondary content is a variable media format or non-variable media format. An advantage can be that the primary content provider has authority and capacity to making functional modifications to the native application, but in practice, no authority or capacity to make functional changes to the secondary content server 42.

Conceptually, secondary content comprises metadata and a payload. The payload comprises the secondary content itself and is not directly accessible by the native application. Instead, the external module is instructed by the native application to access and render the payload. The payload is visualised in the figure as an image, although it may comprise (for example) an HTML instruction to access an external media element. However, the metadata is accessible to the native application. In one embodiment, the metadata includes a display size parameter indicating the display size of the secondary content (e.g., a number of pixels in a first direction and a second direction).

In known examples, the native application reads the display size parameter of the metadata and calls the external module while defining a display size for the external module equal to that specified in the display size parameter. In terms of rendering, an embed window is placed within the corresponding secondary content window 47 with a display size of the display size parameter. As discussed, this can be smaller than the display size of the secondary content window 47.

According to embodiments, the display size parameter can incorporate information enabling the native application to determine whether the media format is a variable media format or a non-variable media format. In a general sense, the information regarding the content of the payload may be understood as being signalled via the particular value of the display size parameter. This information may be referred to as a “resize flag” or “resize signal”.

According to embodiments, a particular display size is selected to indicate the resize flag (i.e., the particular display size is predefined as indicating that the payload comprises a variable media format). In terms of online advertising, it is observed that most ads are associated with one of a relatively small number of predefined display sizes (e.g., as discussed in Reference [3]). Preferably, therefore, the resize flag corresponds to an uncommon advert display size (e.g., a display size not mentioned in Reference [3]). The resize flag can optionally correspond to one of the horizontal number of pixels and vertical number of pixels, or to both.

The native application can therefore effectively “resize” received variable media formats by setting the size of the embedded browser to that of the secondary content window 47 upon identifying the resize flag. However, in cases where an instance of secondary content 45 is not associated with the resize flag, the existing approach of setting the embedded browser to the display size specified by the metadata of the secondary content 45 can be followed. This approach is effective because, for a variable media format, the display size parameter metadata is basically redundant; the display size is determined according to the available display size of the secondary content window 47 (which, as explained, can be set by reference to the physical display area).

In terms of rendering the secondary content 45, this is in effect left to the external module. The native application itself is responsible for setting the display size to be utilised by the external module and arranging the embedded browser (e.g., via its position relative to its secondary content window 47) with respect to the other content of the content display area 48.

In FIG. 13, the second instance of secondary content 45b is shown taking up a portion of the associated secondary content window 47b; therefore, in the example, the second instance of secondary content 45b comprises non-variable media content.

FIG. 14 shows a method for identifying and presenting received variable media formats, according to an embodiment.

At step S700, a native application is opened on a client device 11, for example, as an app running on a smartphone, tablet, or smartwatch. As previous mentioned, the native application can instead be executed on any other suitable computing systems, including desktop computers and laptops. The native application allows for a user to instruct the native application to make a request for primary content 44 (e.g., by providing a search input field for receiving search parameters and instructions).

At step S701, the native application generates a primary content request in response to the native application receiving an instruction (e.g., from the user of the client device 11 via a user interface of the client device 11) to obtain primary content 44. The native application determines request parameters to accompany the primary content request, which typically corresponds to the instruction (i.e., the request parameters are typically based on the user input).

At step S702, the native application communicates, via network 15, the primary content request to the primary content server 41.

At step S703, the native application receives, via the network 15, a primary content response from the primary content server 41. The primary content response comprises one or more instances of primary content 44. At step S704, the native application receives, via the network 15, a secondary content response from the secondary content server 42. The particular order in which the primary content response and secondary content response are received can vary. Furthermore, the secondary content response can be received from the primary content server 41 which itself received it from the secondary content server 42. In this latter case, the primary content response and the secondary content response can be combined into a single combined response sent by the primary content server 41.

At step S704, optionally, the native application generates a preliminary results page defining relative positioning of one or more primary content windows 46, each associated with a received instance of primary content 44, and one or more secondary content windows 47, each associated with a received instance of secondary content 45. The preliminary results page can comprise presentation elements separate to those of the primary content 44 and secondary content 45.

At step S705, the native application selects one of the instances of secondary content 45 and at step S706 checks for a resize flag indicated by metadata of the selected particular instance of secondary content 45.

In a case where the resize flag is present, the method moves to step S707 in which an embedded browser is created within a display portion associated with the secondary content window 47 of the selected secondary content 45. In this case, the embedded browser is created with a display size determined in accordance with the size of the associated secondary content window 47 (e.g., the display size of the embedded browser is set as the same as the associated secondary content window 47). The native application instructs an external module (such as Web View) to render the payload of the particular instance of secondary content 45 within the embedded browser. The method then proceeds to step S709.

In a case where the resize flag is not present, the method moves to step S708 in which an embedded browser is created within a display portion associated with the secondary content window 47 of the selected secondary content 45. In this case (in contrast to step S707), the embedded browser is created with a display size determined in accordance with the display size parameter specified by the metadata of the particular instance of secondary content 45. That is, the display size of the embedded browser is not determined by the display size of the associated secondary content window 47. As with step S707, the native application instructs an external module (such as WebView) to render the payload of the particular instance of secondary content 45 within the embedded browser. The method then proceeds to step S709.

At step S709, the native application checks whether any instances of secondary content 45 remain unchecked. If so, an unchecked instance of secondary content is selected and the method returns to step S706. If not, the method proceeds to step S710.

At step S710, the native application finalises the results page by rendering the instances of primary content 44 in the respective primary content windows 46, noting that the external module renders the instances of secondary content 45 (which forms part of the results page).

It is envisaged that, in an embodiment, the native application is enabled to set a display size of the embedded browser in a case of determining variable media content (i.e., the presence of the resize flag) to a display size different to the originally specified display size of the secondary content window 47. For example, due to predefined rules, the embedded browser can be resized again after the secondary content 45 is first rendered (e.g., to provide a visual effect to the user, the further resize may occur while the user is “browsing” the results page). The secondary content window 47 can be understood as also being resized.

A modification to existing functionality of native applications is described to allow the native application to effectively signal current display states to the content rendered within the embedded browser. It is noted that small changes to the display size of the embedded browser are unlikely to cause noticeable changes to the presentation of the results page. However, the display size of the embedded browser is controllable by the native application and also determinable by the code of the payload being rendered within the embedded browser. For example, JavaScript code executed by WebView is able to identify a current size of the Web View container (in an equivalent manner to which JavaScript is enabled to identify a display size provided by a web browser). Also, CSS and HTML can also, optionally in combination with JavaScript, cause a change in presentation of media content in dependence on the particular resolution of the display size.

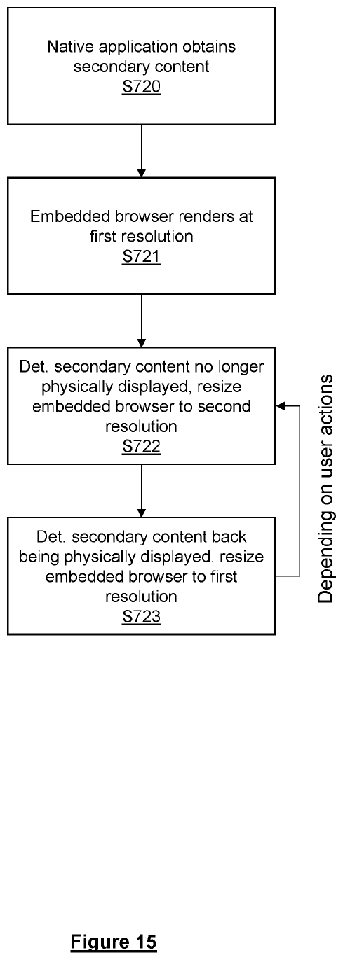

FIG. 15 shows a method for signalling a status to an embedded media content according to an embodiment, the payload includes a video including sound intended to be presented to the user via the display 43. However, it can be desirable to avoid playing sound in certain circumstances. One circumstance is that the video is currently “off-screen”—that is, although it is part of the results page, it is currently not located within the content display area 48 (e.g., because the user has scrolled the results page such as to move the video off-screen).

At step S720, the native application obtains from the secondary content server 42 an instance of secondary content 45 for presenting in a corresponding embedded browser within a corresponding secondary content window 47. S720 can, therefore, in effect utilise, at least in part, the method of FIG. 14.

At step S721, the embedded browser renders the received payload at its current resolution (first resolution), for example, by executing the code of the payload and presenting media defined by said code. In this case, it is assumed that the media comprises a video (a “video perceivable element”). The video also comprises audio playback (an “audio perceivable element”), however, in some implementations the video playback is initially in a muted state. In this latter case, the user is provided with a user interface means (e.g., a touchable icon associated with the video) to “unmute” the video, thereby enabling audio playback.

At step S722, in response to the secondary content window 47 moving outside of the content display area 48 (e.g., due to a user input), the native application changes the size of the embedded browser by a predefined amount to a second resolution. In the present case, the height is reduced by one pixel, which is expected to be unlikely to be noticed by the user but is determinable by the payload code.

At step S723, in response to the secondary content window 47 moving back within the content display area 48 (e.g., due to a user input), the native application changes the size of the embedded browser by a predefined amount to return it to the size before step S722. Generally, steps S722 and S723 can be repeated several times.

Considering now the response of the payload code, it is configured to react to the particular size (i.e., first size and second size) of the embedded browser. Therefore, the payload code is enabled to be responsive to whether the embedded browser is within the content display area 48 or outside of the content display area 48 (i.e., currently not displayed on the display 43. For example, the payload code can define media content having at least one perceivable element when the media content is presented by the client device 11—by “perceivable element”, it is intended to correspond to an output perceivable by the user of the client device 11.

In an embodiment, the payload code is configured to unmute the audio perceivable element when a change from the second resolution to the first resolution occurs on a condition that the audio perceivable element had been set as unmute immediately before the preceding change from first resolution to second resolution (i.e., immediately before step S722). Therefore, the payload code advantageously maintains a memory of the user's preference (mute or unmute) when presenting the embedded browser within the content display area 48.

It should be understood that the native application can be configured to change the resolution of the embedded browser generally according to predefined rules. A predefined rule, as described above, can correspond to whether the embedded browser is presently within the content display area 48, it should be noted that the native application can be configured to change from the first resolution to the second resolution (and vice versa) when a particular part of the embedded browser is outside of the content display area 48 (e.g. whether a centre line of the embedded browser is within or outside of the content display area 48).

Now considering the alternative in which the primary content application corresponds to a web app operated by directing a web browser to a suitable web resource (i.e., is not a native application). In this case, the web browser and web app implement similar functionality to a native application. However, because the web browser and web application are responsible for presenting both of the instance of primary content 44 and the instances of secondary content 45, there is no “barrier” between the payload of the instances of secondary content 45 and the web app. In fact, the results page itself may be defined by code generated by the web server on which the web app is hosted, such that the client device 11 itself does not distinguish between primary content 44 and secondary content 45. In any event, instances of secondary content 45 corresponding to a variable media format can directly indicate this to the web application and web browser, there is no requirement to utilise a “resize flag” in the metadata of the secondary content.

It should be noted that the same secondary content can be utilised by a native application and a web application according to the embodiments herein described, as in either case, in instances of variable media formats, the display size parameter is effectively redundant as the payload of the secondary content 45 comprises suitable code to adapt the presentation of the secondary content 45 to different display sizes.

However, there are many reasons for utilising a native application instead of a web browser for the primary content application. The embodiments herein provide an effective mechanism for enabling the native application to distinguish between variable media formats and non-variable media formats while not having access to the “payload” of the receive secondary content 45. From another perspective, the code provided with the payload is not required to “talk” or otherwise control the size of the embedded browser.

Further modifications can be made without departing from the spirit and scope of the specification. For example, it is envisaged that the native application can be configured to receive and display the secondary content data only; that is, there is no communication with the content first server. This may be applicable where the native application is configured for presenting a variety of content obtained from third parties.

Additionally, although described as separate systems, the communication system 10 and the content system 40 may be implemented together. For example, the secondary content 45 provided by secondary content server 42 of content system 40 may correspond to the content described as being provided by the third-party content server 14 of communication system 10 (in effect, the third-party content server 14 is equivalent to the secondary content server 42).

### REFERENCES

[1] How rich media works: what is rich media? [online]. Google LLC., [retrieved on 2023 Jun. 13]. Retrieved from the Internet:
   <URL: https://support.google.com/richmedia/answer/2417545>
[2] Web View. [online]. Google LLC., [retrieved on 2023 Jun. 19]. Retrieved from the Internet:
   <URL: https://developer.android.com/reference/android/webkit/Web View>
[3] Supported ad sizes. [online]. Google LLC., [retrieved on 2023 Jun. 13]. Retrieved from the Internet:
   <URL: https://support.google.com/admanager/answer/1100453>

1. A propagation server for facilitating propagation of recorded information between first-party data structures associated with different domains,
the propagation server arranged for data communication via a network with web browsers of client devices, wherein the propagation server is associated with a propagation domain being a web domain, wherein the propagation server is configured to:
receive a first request from a first web browser, said first web browser associated with a first client device, wherein the first request identifies a first domain being a web domain different to the propagation domain;
determine, via data communication with the first web browser, whether a propagation data structure, being a first party data structure associated with the propagation domain, is present on the first web browser;
in a case where the propagation data structure is present:
determine an identifier from information stored with the propagation data structure;
generate first propagation information in dependence on the identifier, said first propagation information enabling determination of the identifier by the propagation server in a subsequent data communication instance between the first web browser and the propagation server, wherein said subsequent data communication instance is identified as being associated with the first domain; and
communicate the first propagation information to the first web browser.

2. The propagation server of claim 1, wherein the propagation server is configured to:
in a case where the propagation data structure is not present:
generate an identifier;
generate the first propagation information in dependence on the generated identifier, said first propagation information enabling determination of the generated identifier by the propagation server in a subsequent data communication instance between the first web browser and the propagation server, wherein said subsequent data communication instance is identified as being associated with the first domain; and
communicate the first propagation information to the first web browser.

3. The propagation server of claim 2, wherein the propagation server is configured to:
in response to determining that a propagation data structure is not present, cause a presentation of a user control interface on the first web browser enabling a user of the first web browser to define one or more propagation rules for storing in a propagation rules data structure on the first web browser, wherein the one or more propagation rules are not accessible to data communications from domains different to the propagation domain, and wherein the propagation information is generated in dependence on the defined one or more propagation rules.

4. The propagation server of claim 1, wherein the propagation server is configured to:
receive a propagation rules edit request from the first web browser;
in response, cause a presentation of a configuration interface on the first web browser enabling a user of the first web browser to define and/or modify one or more propagation rules for storing in a propagation rules data structure on the first web browser, wherein the one or more propagation rules are not accessible to data communications from domains different to the propagation domain, and wherein the propagation information is generated in dependence on the defined one or more propagation rules.

5. The propagation server of claim 1, wherein the propagation information is also generated in dependence on one or more propagation rules associated with the propagation data structure.

6. The propagation server of claim 5, wherein the one or more propagation rules define at least two groups of one or more domains, wherein each group comprises different domains to the other groups, such that the propagation information generated in dependence on a particular identifier is the same for domains of a group and different for domains of different groups.

7. The propagation server of claim 6, further interfaced with a match module arranged for data communication via the network, the match module configured to:
receive a first request associated with a first group of the at least two groups, wherein the request identifies one or more first identifiers and specifies at least one second group of the at least two groups, the at least one second group being different to the first group;
obtain second propagation information associated with one or more web browsers from the second group, and convert the second propagation information into one or more second identifiers, each associated with one of the one or more web browsers;
identify, for each of the one or more first identifiers, a match state indicative of the presence or non-presence of an identical second identifier; and
communicating a response to the first group indicating the match state for each of the one or more first identifiers.

8. The propagation server of claim 7, wherein the match module is implemented by the propagation server.

9. The propagation server of claim 7 or claim 8, wherein the first request provides first propagation information associated with one or more web browsers and the match module converts said first propagation information into the one or more first identifiers, thereby identifying the one or more first identifiers.

10. The propagation server of any one of claims 7 to 9, wherein the match module maintains a record of match rules for a plurality of identifiers, and the identified match state for at least one first identifier is dependent on an allowability rule defined the match rule for that at least one identifier.

11. The propagation server of claim 1, wherein the propagation server encrypts the identifier to thereby generate an encrypted identifier for storing with the propagation data structure, and decrypts the encrypted identifier when determining the identifier.

12. The propagation server of claim 1, wherein the propagation server maintains a database of propagation keys, each propagation key associated with one or more domains, and wherein generation of the propagation information comprises encrypting the identifier utilising a first propagation key being associated with the first domain.

13. A network system comprising the propagation server of claim 1, further comprising one or more domain servers, each arranged for data communication via a network with the web browsers of the client devices and each associated with a unique domain, wherein the propagation domain is different to the domains of the domain servers, and wherein each domain server is configured to:
receive a communication from a web browser;
determine whether a first domain data structure is associated the communication, the first domain data structure associated with the domain of the domain server;
in response to determining that there is not a first data structure present, obtain from the web browser propagation information, the propagation information having been obtained by the web browser due to the first request communicated to the propagation server;
generate first domain data structure information based on the received propagation information
instruct the web browser to record in a new first domain data structure the first domain data structure information.

14. The network system of claim 13, wherein the first domain data structure information by encrypting the propagation information utilising a first domain key known to the domain server, the first domain key not utilised in generating the propagation information from the identifier.

15. The network system of claim 14, wherein the propagation server encrypts the identifier to thereby generate an encrypted identifier for storing with the propagation data structure, and decrypts the encrypted identifier when determining the identifier, and wherein each domain server is configured to generated associated domain data structure information by encrypting received propagation information utilising a domain key known to the particular domain server.

16. The network system of claim 15, wherein each domain server is configured to:
receive the propagation information from the web browser after the web browser is instructed to communicate with the propagation server, said propagation information provided to the web browser due to its communication with the propagation server.

17. The propagation server of claim 1, wherein the propagation data structure comprises a propagation cookie in which at least the information for determining the identifier is stored.

18. A propagation server for facilitating propagation of recorded information between first-party data structures associated with different domains,
the propagation server arranged for data communication via a network with web browsers of client devices, wherein the propagation server is associated with a propagation domain being a web domain, wherein the propagation server is configured to:
receive a first request from a first web browser, said first web browser associated with a first client device, wherein the first request identifies a first domain being a web domain different to the propagation domain;
determine, via data communication with the first web browser, whether a propagation data structure, being a first party data structure associated with the propagation domain, is present on the first web browser;
in a case where the propagation data structure is not present:
generate an identifier;
generate the first propagation information in dependence on the generated identifier, said first propagation information enabling determination of the generated identifier by the propagation server in a subsequent data communication instance between the first web browser and the propagation server, wherein said subsequent data communication instance is identified as being associated with the first domain; and
communicate the first propagation information to the first web browser.

19. The network system of claim 18, wherein the propagation data structure comprises a propagation cookie in which at least the information for determining the identifier is stored.

20. A method for facilitating propagation of recorded information between first-party data structures associated with different domains, the method comprising:
at a propagation server arranged for data communication via a network with web browsers of client devices, wherein the propagation server is associated with a propagation domain being a web domain:
receiving a first request from a first web browser, said first web browser associated with a first client device, wherein the first request identifies a first domain being a web domain different to the propagation domain;
determining, via data communication with the first web browser, that a propagation data structure is present, being a first party data structure associated with the propagation domain, is present on the first web browser;
in response, determining an identifier from information stored with the propagation data structure;
generating first propagation information in dependence on the identifier, said first propagation information enabling determination of the identifier by the propagation server in a subsequent data communication instance between the first web browser and the propagation server, wherein said subsequent data communication instance is identified as being associated with the first domain; and
communicating the first propagation information to the first web browser.

21. A method for facilitating propagation of recorded information between first-party data structures associated with different domains, the system comprising:
at a propagation server arranged for data communication via a network with web browsers of client devices, wherein the propagation server is associated with a propagation domain being a web domain:
receiving a first request from a first web browser, said first web browser associated with a first client device, wherein the first request identifies a first domain being a web domain different to the propagation domain;
determining, via data communication with the first web browser, that a propagation data structure, being a first party data structure associated with the propagation domain, is present on the first web browser, is not present;
in response, generating an identifier;
generating the first propagation information in dependence on the generated identifier, said first propagation information enabling determination of the generated identifier by the propagation server in a subsequent data communication instance between the first web browser and the propagation server, wherein said subsequent data communication instance is identified as being associated with the first domain; and
communicating the first propagation information to the first web browser.

22. A method for providing a responsive display of content rendered in an embedded browser on a client device having a display and a user interface for receiving instructions from a user of the client device and being configured for data communication with a network, comprising:
running a native application on the client device, wherein the native application is configured for presenting on the display of the client device a visual representation of both of received primary content data and received secondary content data, wherein the native application is configured for generating a presentation of the received primary content data, wherein the secondary content data is associated with received metadata readable to the native application and comprises a payload defining presentable media content, wherein the payload is not readable by the native application, and wherein the native application utilises the embedded browser for generating and displaying a presentation of the payload;
receiving, by the native application via the network, secondary content data from a secondary content server in response to a request for primary content data being communicated to the primary content server;
determining, by the native application, whether the metadata indicates that the payload defines a variable media format indicative that the received media content is suitable for presentation at a native application determined display size; and
in response to determining that the payload defines a variable media format:
determining, by the native application, a system specific display resolution for presenting the media content defined by the payload, wherein the system specific display resolution is determined independently of a secondary content display resolution defined by the metadata, and
instructing, by the native application, the embedded browser to generate and display a presentation of the payload on the display of the client device at a display size equal to the determined system specific display resolution.

23. A client device comprising a processor operably interfaced with a memory, a display, a user interface for receiving instructions from a user of the client device, and a network interface for enabling data communication between the client device and a network, wherein the display has a physical display size, wherein the memory comprises code defining operation of a native application, wherein the native application is configured to cause, when executed by the processor, the client device to provide a responsive display of content rendered in an embedded browser, and wherein the native application is configured to cause the client device to:
receive via the network secondary content data from a secondary content server in response to a request for primary content data being communicated to the primary content server, wherein the secondary content data is associated with received metadata readable by the native application and comprising a payload defining presentable media content, wherein the payload is not readable by the native application;
determine whether the metadata indicates that the payload defines a variable media format indicative that the received media content is suitable for presentation at a native application determined display size; and
in response to determining that the payload defines a variable media format:
determine a system specific display resolution for presenting the media content defined by the payload, wherein the system specific display resolution is determined independently of a secondary content display resolution defined by the metadata, and
instruct an embedded browser of the client device to generate and display a presentation of the media content of the payload on the display at a display size equal to the determined system specific display resolution.

24. A native application for providing a responsive display of content rendered in an embedded browser on a client device, wherein the client device comprises a processor operably interfaced with a memory, a display, a user interface for receiving instructions from a user of the client device, and a network interface for enabling data communication between the client device and a network, wherein the display has a physical display size, wherein the native application comprises code configured to cause, when said code is executed by said processor, the client device to:
receive via the network secondary content data from a secondary content server in response to a request for primary content data being communicated to the primary content server, wherein the secondary content data is associated with received metadata readable by the native application and comprising a payload defining presentable media content, wherein the payload is not readable by the native application;
determine whether the metadata indicates that the payload defines a variable media format indicative that the received media content is suitable for presentation at a native application determined display size; and
in response to determining that the payload defines a variable media format:
determine a system specific display resolution for presenting the media content defined by the payload, wherein the system specific display resolution is at least in part determined according to the physical resolution of the display, and
instruct an embedded browser of the client device to generate and display a presentation of the media content of the payload on the display at a display size equal to the determined system specific display resolution.

25. A method for providing a responsive display of content rendered in an embedded browser on a client device comprising a display and a user interface for receiving instructions from a user of the client device and being configured for data communication with a network, comprising:
running a native application on the client device, wherein the native application is configured for presenting to a user of the client device a representation of both of received primary content data and received secondary content data, wherein the native application is configured for generating a presentation of the received primary content data, wherein the secondary content data comprises a payload defining presentable media content, and wherein the native application utilises the embedded browser for generating and presenting a representation of the media content defined by the payload;
receiving, by the native application via the network, secondary content data from a secondary content server in response to a request for primary content data being communicated to the primary content server;
generating, by the native application, a combined presentation comprising the embedded browser, wherein the combined presentation has a display size larger than a content display area of the display such that a particular portion of the combined presentation is displayable on the display at a time, wherein the user is enabled to provide an input to control the particular portion of the combined presentation being displayed;
displaying a first portion of the combined presentation on the display, the first portion comprising the embedded browser, wherein the embedded browser is instructed, by the native application, to present the media content defined by the payload in the first portion according at a first resolution;
determining a change such that a second portion of the combined presentation is displayed on the display, the second portion not comprising the embedded browser; and
in response, instructing the embedded browser to present the media content defined by the payload at a second resolution, different to the first resolution,
wherein the payload is responsive to the change in resolution from the first resolution to the second resolution, such that at least one perceivable element of the presentation of the media content defined by the payload is different at the second resolution when compared to the first resolution.

26. A client device comprising a processor operably interfaced with a memory, a display, a user interface for receiving instructions from a user of the client device, and a network interface for enabling data communication between the client device and a network, wherein the memory comprises code defining operation of a native application, wherein the native application is configured to cause, when executed by the processor, the client device to provide a responsive display of content rendered in an embedded browser, and wherein the native application is configured to cause the client device to:
receive, by the native application via the network, secondary content data from a secondary content server in response to a request for primary content data being communicated to the primary content server, wherein the secondary content data comprises a payload defining presentable media content, and wherein the native application utilises the embedded browser for generating and presenting a representation of the media content defined by the payload;
generate, by the native application, a combined presentation comprising the embedded browser, wherein the combined presentation has a display size larger than a content display area of the display such that a particular portion of the combined presentation is displayable on the display at a time, wherein the user is enabled to provide an input to control the particular portion of the combined presentation being displayed;
display a first portion of the combined presentation on the display, the first portion comprising the embedded browser, wherein the embedded browser is instructed, by the native application, to present the media content defined by the payload in the first portion according at a first resolution;
determine a change such that a second portion of the combined presentation is displayed on the display, the second portion not comprising the embedded browser; and
in response, instruct the embedded browser to present the media content defined by the payload at a second resolution, different to the first resolution,
wherein the payload is responsive to the change in resolution from the first resolution to the second resolution, such that at least one perceivable element of the presentation of the media content defined by the payload is different at the second resolution when compared to the first resolution.

27. A native application for providing a responsive display of content rendered in an embedded browser on a client device, wherein the client device comprises a processor operably interfaced with a memory, a display, a user interface for receiving instructions from a user of the client device, and a network interface for enabling data communication between the client device and a network, wherein the memory comprises code defining operation of a native application, wherein the native application is configured to cause, when executed by the processor, the client device to:
receive, by the native application via the network, secondary content data from a secondary content server in response to a request for primary content data being communicated to the primary content server, wherein the secondary content data comprises a payload defining presentable media content, and wherein the native application utilises the embedded browser for generating and presenting a representation of the media content defined by the payload;
generate, by the native application, a combined presentation comprising the embedded browser, wherein the combined presentation has a display size larger than a content display area of the display such that a particular portion of the combined presentation is displayable on the display at a time, wherein the user is enabled to provide an input to control the particular portion of the combined presentation being displayed;
display a first portion of the combined presentation on the display, the first portion comprising the embedded browser, wherein the embedded browser is instructed, by the native application, to present the media content defined by the payload in the first portion according at a first resolution;
determine a change such that a second portion of the combined presentation is displayed on the display, the second portion not comprising the embedded browser; and
in response, instruct the embedded browser to present the media content defined by the payload at a second resolution, different to the first resolution,
wherein the payload is responsive to the change in resolution from the first resolution to the second resolution, such that at least one perceivable element of the presentation of the media content defined by the payload is different at the second resolution when compared to the first resolution.
